(19) United States
(12) Patent Application Publication
(10) Pub. No.: US 2024/0335026 A1
(43) Pub. Date: Oct. 10, 2024

(54) BRUSH HEAD BODY, BRUSH HEAD, AND TOOTHBRUSH

(71) Applicant: GUANGZHOU STARS PULSE CO.,LTD., GUANGZHOU (CN)

(72) Inventors: HUIJIA LIANG, GUANGZHOU (CN); JUNWEN LAI, GUANGZHOU (CN); ZHUOYING LI, GUANGZHOU (CN)

(21) Appl. No.: 18/747,705

(22) Filed: Jun. 19, 2024

Related U.S. Application Data
(63) Continuation of application No. PCT/CN2024/080435, filed on Mar. 7, 2024.

(30) Foreign Application Priority Data
Mar. 17, 2023 (CN) 202320549011.X
Mar. 17, 2023 (CN) 202320549037.4
Mar. 17, 2023 (CN) 202320549084.9
Sep. 20, 2023 (CN) 202322571430.6
Sep. 20, 2023 (CN) 202322571472.X

(51) Int. Cl. A46B 3/20; A46B 5/00; A46B 7/06; A46B 9/02; A46B 9/04; A46B 13/02; A61C 17/22

(52) U.S. Cl. CPC A46B 3/20; A46B 5/0029; A46B 7/06; A46B 9/026; A46B 9/04; A46B 13/023; A61C 17/222

(57) ABSTRACT

A brush head body includes a brush neck portion extending in a first direction, a brush plate disposed on the brush neck portion and an elastic structure. The brush plate includes a middle mounting portion and two side mounting portions disposed on two sides of the middle mounting portion in a second direction. At least one of the side mounting portions and the middle mounting portion is connected to the brush neck portion. The middle mounting portion and the side mounting portions include fixing rings for mounting bristle bundles. In a third direction, a thickness of each of the fixing rings of the middle mounting portion is greater than a thickness of each of the fixing ring of the side mounting portions. The first direction, the second direction and the third direction are perpendicular to each other. The elastic structure wraps outer peripheral walls of the fixing rings.

### TECHNICAL FIELD

The present disclosure relates to a field of toothbrushes, and in particular to a brush head body, a brush head, and a toothbrush.

### BACKGROUND

In the related art, bristles of a toothbrush are fixed into a hard brush plate. When the bristles are soft, although soft bristles have good flexibility and a large swing range, cleaning power thereof is poor. In order to ensure a cleaning effect, it is necessary to use thicker and harder bristles, and the hard brush plate is fixed with the thicker and harder bristles. When a motor of the toothbrush runs and drives the thicker and harder bristles to resonate with the hard brush plate, if a driving force is strong, gums are irritated to bleed.

### SUMMARY

The present disclosure aims to solve technical problems in the related art to a certain extent.

The present disclosure provides a brush head. The brush head comprises a brush rod extending in a first direction, a brush plate disposed on the brush rod, and an elastic structure. The brush plate comprises a middle mounting portion and two side mounting portions. The two side mounting portions are respectively disposed on two sides of the middle mounting portion in a second direction. At least one of the side mounting portions and the middle mounting portion is connected to the brush rod. The middle mounting portion and the side mounting portions comprise fixing rings for mounting bristle bundles. In a third direction, a thickness of each of the fixing rings of the middle mounting portion is greater than a thickness of each of the fixing ring of the side mounting portions. The first direction, the second direction and the third direction are perpendicular to each other. The elastic structure wraps outer peripheral walls of the fixing rings.

The present disclosure provides a toothbrush. The toothbrush comprises a brush handle and a brush head. The brush head comprises a brush rod extending in a first direction, a brush plate disposed on the brush rod, and an elastic structure. The brush plate comprises a middle mounting portion and two side mounting portions. The two side mounting portions are respectively disposed on two sides of the middle mounting portion in a second direction. At least one of the side mounting portions and the middle mounting portion is connected to the brush rod. The middle mounting portion and the side mounting portions comprise fixing rings for mounting bristle bundles. In a third direction, a thickness of each of the fixing rings of the middle mounting portion is greater than a thickness of each of the fixing ring of the side mounting portions. The first direction, the second direction and the third direction are perpendicular to each other. The elastic structure wraps outer peripheral walls of the fixing rings.

The toothbrush of the embodiments of the present disclosure has good practicality and high user satisfaction.

Additional aspects and advantages of the present disclosure are set forth in part in the description as follows, or in part becomes obvious according to the description, or may be learned by practice of the present disclosure.

### BRIEF DESCRIPTION OF DRAWINGS

FIG. 1 is a perspective schematic diagram of a brush head according to one embodiment of the present disclosure.

FIG. 2 is a front side elevational schematic diagram of the brush head according to one embodiment of the present disclosure.

FIG. 3 is a structural schematic diagram of a brush head body according to one embodiment of the present disclosure.

FIG. 4 is a side schematic diagram of the brush head body according to one embodiment of the present disclosure.

FIG. 5 is a structural schematic diagram of the brush head body according to another embodiment of the present disclosure.

FIG. 6 is a structural schematic diagram of the brush head body according to another embodiment of the present disclosure.

FIG. 7 is a perspective schematic diagram of the brush head body shown in FIG. 6.

FIG. 8 is a structural schematic diagram of the brush head body according to another embodiment of the present disclosure.

FIG. 9 is a structural schematic diagram of a bristle bundle according to another embodiment of the present disclosure.

FIG. 10 is a structural schematic diagram of a bristle fixing hole according to another embodiment of the present disclosure.

FIG. 11 is a structural schematic diagram of a toothbrush according to another embodiment of the present disclosure.

FIG. 12 is a structural schematic diagram of the brush head according to another embodiment of the present disclosure.

FIG. 13 is an exploded structural schematic diagram of the brush head according to another embodiment of the present disclosure.

FIG. 14 is a cross-sectional schematic diagram of the brush head taken along the line A-A shown in FIG. 12.

FIG. 15 is another structural schematic diagram of the brush head according to another embodiment of the present disclosure.

FIG. 16 is a perspective cross-sectional schematic diagram of the brush head according to another embodiment of the present disclosure.

FIG. 17 is a partial cross-sectional schematic diagram of the brush head according to another embodiment of the present disclosure.

FIG. 18 is a structural schematic diagram of fixing rings according to one embodiment of the present disclosure.

FIG. 19 is a structural schematic diagram of the fixing rings according to another embodiment of the present disclosure.

FIG. 20 is a partial schematic diagram of the brush head according to another embodiment of the present disclosure.

FIG. 21 is an enlarged schematic diagram of portion A shown in FIG. 17.

FIG. 22 is a structural schematic diagram of the brush head according to another embodiment of the present disclosure.

### DETAILED DESCRIPTION

Embodiments of the present disclosure are described in detail below. Examples of the embodiments are shown in accompanying drawings, in which same or similar reference numerals indicate the same or similar elements or elements with the same or similar functions. The embodiments described below with reference to the drawings are exemplary, and are intended to explain the present disclosure, but should not be regarded as a limitation to the present disclosure.

The brush head body 119 of embodiments of the present disclosure is described below with reference to the accompanying drawings.

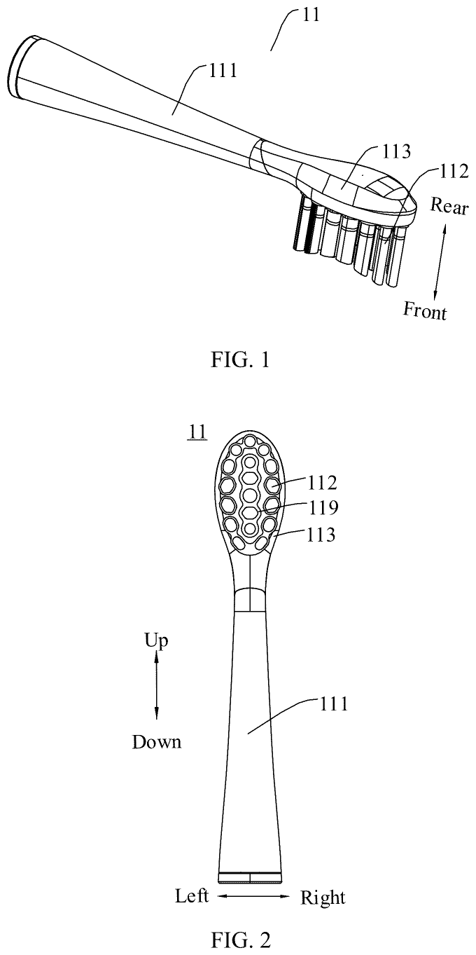

It should be noted that a first direction L is an up-down direction shown in FIG. 2, a second direction X is a left-right direction shown in FIG. 2, and a third direction Y is a front-rear direction shown in FIG. 1. The first direction L, the second direction X, and the third direction Y are perpendicular to each other.

As shown in FIGS. 1-7, embodiments of the present disclosure provide a brush head body 119. The brush head body 119 comprises a brush neck portion 1191 and a brush plate 1192.

The brush neck portion 1191 extends in the first direction L. The brush plate 1192 is disposed on the brush neck portion 1191. The brush plate 1192 comprises a middle mounting portion 1194 and two side mounting portions 1195. The two side mounting portions 1195 are respectively disposed on two sides of the middle mounting portion 1194 in the second direction X. At least one of the middle mounting portion 1194 and the two side mounting portions 1195 is connected to the brush neck portion 1191. The middle mounting portion 1194 and the two side mounting portions 1195 comprise fixing rings 114 configured to mount bristle bundles 112. In the third direction Y, a thickness of each of the fixing rings 114 of the middle mounting portion 1194 is greater than a thickness of each of the fixing rings 114 of the two side mounting portion. The first direction L, the second direction X, and the third direction Y are perpendicular to each other.

As a result, a binding force of the middle mounting portion 1194 on the bristle bundles 112 is increased, so that the bristle bundles 112 mounted on the middle mounting portion 1194 are not easy to pull off and have good vibration transmission performance, which improves mounting stability and cleaning efficiency of the bristle bundles 112.

For instance, as shown in FIGS. 1-4, the brush head body 119 comprises the brush neck portion 1191 and the brush plate 1192. The brush neck portion 1191 extends in the first direction L. A first end of the brush neck portion 1191 is connected to the brush rod 111. The brush rod 111 is configured as a round rod, a square rod, or other structures that are easy for a user to hold. A second end of the brush neck portion 1191 is connected to the brush plate 1192. The brush plate 1192 extends linearly or obliquely in the first direction L. The brush plate 1192 comprises the middle mounting portion 1194 and the two side mounting portions 1195. In the second direction X, the two side mounting portions 1195 are respectively disposed on the two sides of the middle mounting portion 1194.

Furthermore, at least one of the two side mounting portions 1195 and the middle mounting portion 1194 is connected to the brush neck portion 1191. Specifically, at least one of the side mounting portions 1195 is connected to the brush neck portion 1191, and the middle mounting portion 1194 is connected to a corresponding side mounting portion 1194. Alternatively, the side mounting portions 1195 and the middle mounting portion 1194 are connected to the brush neck portion 1191. Alternatively, the middle mounting portion 1194 is connected to the brush neck portion 1191, and at least one of the side mounting portions 11952 is connected to the middle mounting portion 1194, which is not limited thereto.

The middle mounting portion 1194 and the two side mounting portions 1195 comprises the fixing rings 114. The fixing rings 114 are disposed sequentially. The fixing rings 114 define bristle fixing holes, and each of the fixing ring 114 defines a bristle fixing hole 114A. Each of the bristle fixing holes 114A penetrates a corresponding fixing ring 114 in the third direction Y, so that the bristle fixing holes 114A are through holes. A fixing end of each of the bristle bundles 112 extend into a corresponding bristle fixing hole 114A from a first end of the corresponding bristle fixing hole 114A and extend to a second end of the corresponding bristle fixing hole 114A. The fixing end of each of the bristle bundles 112 is melted to form a head portion 1122. There are many head portions, and each of the head portions 1122 is configured to fix a corresponding bristle bundle 112 on a corresponding fixing ring 114. A free end of each of the bristle bundles 112 extends outwards in the third direction Y from the corresponding bristle fixing hole 114A and the bristle bundles 112 are configured to clean an oral cavity of a human body.

It should be emphasized that an extension direction of the bristle bundles 112 is not absolutely parallel to the third direction Y, but may also form a certain angle with the third direction Y. The certain angle between the bristle bundles 112 and the third direction Y is 0°-30°, which is not limited thereto.

A thickness of the fixing rings 114 of the middle mounting portion 1194 in the third direction Y is greater than a thickness of the fixing rings 114 of the two side mounting portions 1195, so that a depth of the bristle fixing holes 114A on the middle mounting portion 1194 is greater than a depth of the bristle fixing holes 114A on the two side mounting portions 1195, which increases a contact area between the middle mounting portion 1194 and corresponding bristle bundles 112, so that the bristle bundles 112 fixed on the middle mounting portion 1194 are difficult to pull off and have high vibration intensity. Therefore, the mounting stability and cleaning efficiency of the bristle bundles 112 is improved.

In the embodiment of the brush head body 119 of the present disclosure, the thickness of the fixing rings 114 of the middle mounting portion 1194 in the third direction Y is greater than the thickness of the fixing rings 114 of the two side mounting portions 1195, so that the bristle fixing holes 114A on the middle mounting portion 1194 have a large depth, which increases the contact area between the middle mounting portion 1194 and corresponding bristle bundles 112, thereby improving a binding force of the middle mounting portion 1194 on the bristle bundles 112, making the bristle bundles 112 fixed on the middle mounting portion 1194 difficult to pull off and having high vibration intensity. Therefore, the mounting stability and cleaning efficiency of the bristle bundles 112 is improved, and reliability of the brush head body 119 is improved.

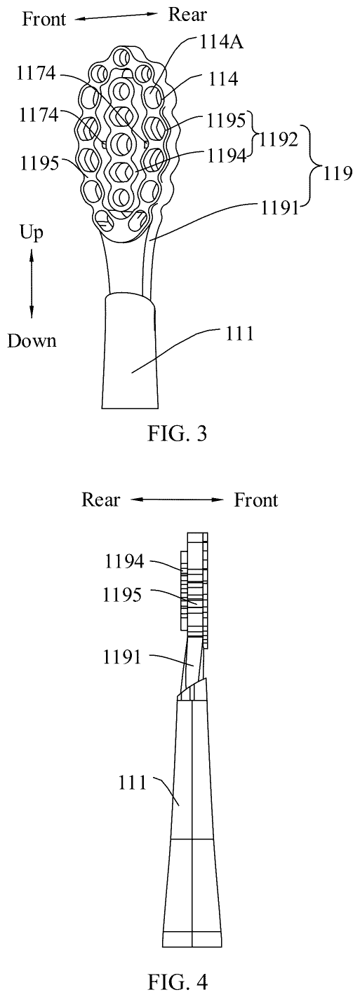

In some embodiments of the brush head body 119 of the present disclosure, in the third direction Y, the middle mounting portion 1194 and one side of each of the side mounting portions 1195 are located on a same plane. For instance, as shown in FIGS. 3 and 4, one side of the middle mounting portion 1194 facing the bristle bundles 112 and sides of the two side mounting portions 1195 facing the bristle bundle 112 are located on the same plane, so that the bristle bundles 112 on the brush plate 1192 are mounted on a same mounting reference surface, which reduces a mounting difficulty of the bristle bundles 112.

In some embodiments of the brush head body 119 of the present disclosure, in the third direction Y, two ends of the middle mounting portion 1194 are raised with respect to the two side mounting portions 1195. For instance, in the third direction Y, two sides of the two side mounting portions 1195 are located on the same plane, and the two ends of the middle mounting portion 1194 are respectively protruded from a plane where two sides of the two side mounting portions 1195 is located, so that the middle mounting portion 1194 is thicker than the two side mounting portion, which improves a structural strength of the middle mounting portion 1194, thus improving a structural strength of the brush plate 1192.

In some embodiments of the brush head body 119 of the present disclosure, in the third direction Y, a first end of the middle mounting portion 1194 is raised with respect to the two side mounting portions 1195 and a second end of the middle mounting portion 1194 is recessed with respect of the two side mounting portions 1195.

For instance, two sides of the two side mounting portions 1195 are disposed on the same plane, the first end of the middle mounting portion 1194 is raised with respect to the plane where the two side mounting portions is located, and the second end of the middle mounting portion 1194 is recessed with respect to the plane where the two side mounting portions is located. Therefore, one side of the brush plate 1192 facing the free end of each of the bristle bundles 112 is uneven, so that the bristle bundles 112 are staggeredly distributed. Thus, diversified arrangements of the bristle bundles 112 are realized.

In some embodiments of the brush head body 119 of the present disclosure, in the third direction X, a wall thickness of the middle mounting portion 1194 is greater than a wall thickness of each of the two side mounting portions 1195.

By such arrangement, the middle mounting portion 1194 has a higher structural strength, and the middle mounting portion 1194 is served as a supporting frame to enable the brush plate 1192 having a higher structural strength, thereby increasing the vibration intensity of the bristle bundle 112 and improving the cleaning efficiency of the bristle bundles 112.

In some embodiments of the brush head body 119 of the present disclosure, when being subjected to a brushing force, a deformation quantity of the middle mounting portion 1194 is less than a deformation quantity of each of the side mounting portions 1195. For instance, a rigidity of the middle mounting portion 1194 is greater than the brush neck portion 1191, or the middle mounting portion 1194 itself has a higher rigidity. That is, the middle mounting portion 1194 is served as a supporting frame for the brush plate, so that the middle mounting portion 1194 is not easily deformed when brushing teeth. The middle mounting portion 1194 apply a contact force to the teeth, ensuring cleaning performance of the bristle bundles 112 on the middle mounting portion 1194. The side mounting portions 1195 are prone to deformation and are able to better adapt to shapes of the teeth, which improve a cleaning effect, provide a certain buffer to improve comfort of brushing, and avoid damaging the teeth.

In some embodiments of the brush head body 119 of the present disclosure, in the third direction Y, the thickness of each of the fixing rings 114 of the middle mounting portion 1194 is 4-7 mm, and a thickness of each of the fixing rings 114 of the two side mounting portions 1195 is 2-4 mm. For instance, in the third direction Y, the thickness of each of the fixing rings 114 of the middle mounting portion 1194 is 5 mm; or the thickness of each of the fixing rings 114 of the middle mounting portion 1194 is 5.5 mm; or the thickness of each of the fixing rings 114 of the middle mounting portion 1194 is 6 mm, which is not limited thereto. Further, in the third direction Y, the thickness of each of the fixing rings 114 of the side mounting portions 1195 is 2.5 mm; or the thickness of each of the fixing rings 114 of the side mounting portions 1195 is 3 mm; or the thickness of each of the fixing rings 114 of the side mounting portions 1195 is 3.5 mm, which is not limited thereto.

By above arrangements, the brush plate 1192 has sufficient structural strength, which improves the cleaning efficiency of the bristle bundles 112 and prevents bringing a foreign body sensation to the use due to an excessive size of the brush plate 1192, thereby improving the comfort of the user.

In some embodiments of the brush head body 119 of the present disclosure, areas of cross sections of at least part of the fixing rings 114 of the middle mounting portion 1194 are different from areas of cross sections of at least part of the fixing rings 114 of the two side mounting portions 1195. For instance, a cross-sectional area of each of the fixing rings 114 of the middle mounting portion 1194 is relatively small, so that a cross-sectional area of a corresponding bristle fixing hole 114A is small and, a cross-sectional area of a corresponding bristle bundle 112 is small. Alternatively, a cross-sectional area of each of the fixing rings 114 of the side mounting portions 1195 is relatively small, so that across-sectional area of the corresponding bristle fixing hole 114A is small and a cross-sectional area of a corresponding bristle bundle 112 is small, which is not specifically limited thereto. As a result, the bristle bundles 112 are flexibly disposed, so that the bristle bundles 112 fit the teeth of the user more closely, which avoids missing brushing some teeth, improves the cleaning effect, and improves the comfort of the user.

In some embodiments of the brush head body 119 of the present disclosure, shapes of the at least part of the fixing rings 114 of the middle mounting portion 1194 are different from shapes of the at least part of the fixing rings 114 of the two side mounting portions 1195.

For instance, a shape of each of the fixing rings 114 of the middle mounting portion 1194 is set to be circular, so that a shape of cross sections of the corresponding bristle fixing hole 114A is circular shape and a shape of cross sections of the corresponding bristle bundle 112 is circular. Similarly, the shape of each of the fixing rings 114 of the side mounting portions 1195 is set to be elliptical, so that a shape of cross sections of the corresponding bristle fixing hole 114A is elliptical and a shape of cross sections of the corresponding bristle bundle 112 is elliptical. Of course, the shape of each of the fixing rings 114 may be rectangular, triangular, trapezoidal, etc., which is not limited thereto. In this way, the bristle bundles 112 of different shapes cause bristles at different positions to generate different forces when the bristle bundles contact the teeth (for example, directions and magnitudes of the forces are different), and a contact area between the bristle bundles and the teeth increases. By above arrangements, practicality of the brush head body 119 is improved.

In some embodiments of the brush head body 119 of the present disclosure, the middle mounting portion 1194 comprises the fixing rings 114 sequentially disposed in the first direction L. For instance, as shown in FIG. 3, the middle mounting portion 1194 extends linearly or obliquely in the first direction L. The middle mounting portion 1194 comprises the fixing rings 114 thereof, and the fixing rings 114 are sequentially disposed in the first direction L. Side walls of each two adjacent fixing rings 114 of the middle mounting portion 1194 facing each other are connected to be integrated into a whole. The bristle bundles 112 corresponding to the fixing rings 114 of the middle mounting portion 1194 are respectively mounted in the bristle fixing holes 114A thereof. The bristle bundles 112 are used together for cleaning the teeth to improve cleaning efficiency. Thus, practicality of a main body of the brush plate 1192 is improved.

In some embodiments of the brush head body 119 of the present disclosure, as shown in FIG. 3, at least part of adjacent fixing rings 114 of the middle mounting portion 1194 share a side wall thereof. By such arrangements, more fixing rings 114 are allowed to be defined on the middle mounting portion 1194, which increases an area ratio of the bristle bundles 112 on the middle mounting portion 1194 and the structural strength of the middle mounting portion, thereby increasing an overall vibration intensity and improving cleaning efficiency.

In some embodiments of the brush head body 119 of the present disclosure, the middle mounting portion 1194 is swingable with respect to the brush neck portion 1191. By above arrangement, the bristle bundles 112 on the middle mounting portion 1194 have a larger swing range, which reduces damage to the gums and enamel of the user by the bristle bundles 112 and improves the comfort of the user.

In some embodiments of the brush head body of the present disclosure, one end of the middle mounting portion 1194 facing the brush neck portion 1191 is spaced apart from the brush neck portion 1191, and the middle mounting portion 1194 is connected to at least one of the two side mounting portions 1195 through at least one first connecting piece. For instance, as shown in FIG. 3, the two side mounting portions 1195 are connected to the brush neck portion 1191, and one end of the middle mounting portion 1194 toward the brush neck portion 1191 is spaced apart from the brush neck portion 1191. The middle mounting portion 1194 is connected to at least one of the side mounting portions through the at least one first connecting piece 1174. A width of the at least one first connecting piece 1174 is relatively small, so that the middle mounting portion 1194 is swingable with respect to at least one of the side mounting portions 1195, and the middle mounting portion 1194 is swingable with respect to the brush neck portion 1191. It should be noted that the width of the at least one first connecting piece 1174 is 0.8 mm-1.2 mm, and is preferably 1 mm.

Specifically, the middle mounting portion 1194 is connected to only one of the side mounting portions 1195 through one first connecting piece 1174, so that the swing range of the middle mounting portion 1194 is larger and the brush plate 1192 has a higher freedom degree and a stronger shock absorption effect; Alternatively, the middle mounting portion 1194 is connected to the two side mounting portions 1195 through two first connecting pieces 1174 to increase a connection strength between the side mounting portions 1195 and the middle mounting portion 1194, so that the brush plate 1192 is not easily deformed.

By above arrangement, an integrity of the brush head body 119 is improved, which reduces the number of parts of the brush head body and facilitate integrated molding of the brush head body. In a process of placing the brush head body 119 into a mold to install the elastic structure 113, there is no need to separately fix the middle mounting portion 1194 and the side mounting portions 1195, which reduces a difficulty of processing.

In some embodiments of the brush head body of the present disclosure, the middle mounting portion 1194 is connected to the two side mounting portions 1195 through the first connecting pieces respectively disposed on middle portions of two opposite side walls of the middle mounting portion 1194. For instance, as shown in FIG. 3, the first connecting pieces 1174 are disposed the middle portions of the middle mounting portion 1194 in the first direction L. Each of the first connecting pieces 1174 is configured to connect a side wall of the middle mounting portion 1194 facing a corresponding side mounting portion 1195 to a side wall of the corresponding side mounting portion 1195. In this way, distances between the two ends of the middle mounting portion 1194 in the first direction L respectively to first connecting pieces 1174 are equal, so that swing ranges of the two ends of the middle mounting portion 1194 in the first direction L are the same. Therefore, it avoids the swing ranges of the two ends of the middle mounting portion 1194 in the first direction L being too large or too small, which improves rationality of a design of the brush head body 119.

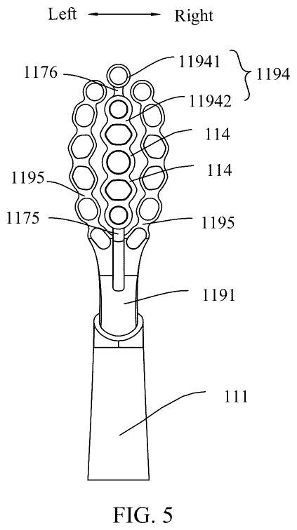

In some embodiments of the brush head body 119 of the present disclosure, the one end of the middle mounting portion 1194 facing the brush neck portion 1191 is connected to the brush neck portion 1191 through a second connecting piece. For instance, as shown in FIG. 5, the two side mounting portions 1195 are connected to the brush neck portion 1191, and the one end of the middle mounting portion 1194 facing the brush neck portion 1191 is connected to the brush neck portion 1191 through the second connecting piece 1175. A width of the second connecting piece 1175 is relatively small, so that the middle mounting portion 1194 is swingable with respect to the brush neck portion 1191. Specifically, the width of the second connecting piece 1175 is 0.8-1.2 mm, and is preferably 1 mm.

By above arrangement, the side mounting portions 1195 and the middle mounting portion 1194 are separated from each other. The side mounting portions 1195 and the middle mounting portion 1194 are swingable, which reduces the damage of the bristle bundle 112 to the gums and enamel of the user, reduces a structural complexity of the brush head body 119, and improves the structural strength of the brush head body 119.

In some embodiments of the brush head body 119 of the present disclosure, in the third direction Y, two sides of the second connecting piece 1175 do not exceed a corresponding fixing ring 114, and two sides of the each of first connecting pieces 1174 do not exceed a corresponding fixing ring 114. By above arrangement, the second connecting piece 1175 and the first connecting pieces 1174 are prevented from protruding from the fixing rings 114 to form bulges on the side walls of the brush plate 1192, thereby improving smoothness of the side walls of the brush plate 1192, which reduces the foreign body sensation brought to the user and improves the user satisfaction.

In some embodiments of the brush head body 119 of the present disclosure, the middle mounting portion 1194 comprises a first fixing ring group 11941 and a second fixing ring group 11942. The first fixing ring group 11941 is located at an end portion of the middle mounting portion 1194 and is connected to the second fixing ring group 11942 through a third connecting piece 1176. The first fixing ring group 11941 is capable of swinging with respect to the second fixing ring group 11942. The first fixing ring group 11941 comprises at least one fixing ring 114. The second fixing ring group 11942 comprises a plurality of fixing rings 114.

For instance, as shown in FIG. 5, the middle mounting portion 1194 comprises the first fixing ring group 11941 and the second fixing ring group 11942. The second fixing ring group 11942 is connected to the brush neck portion 1191 through the second connecting piece 1175, the second fixing ring group 11942 is swingable with respect to the brush neck portion 1191, and the second fixing ring group 11942 comprises the plurality of fixing rings 114. The first fixing ring group 11941 is disposed on one end of the middle mounting portion 1194 away from the brush neck portion 1191. The first fixing ring group 11941 is connected to one end, away from the brush neck portion 1191, of the second fixing ring group 11942 (i.e., a free end of the second fixing ring group) through the third connecting piece 1176., so that the first fixing ring group 11941 is swingable with respect to the second fixing ring group 11942. The first fixing ring group 11941 comprises the at least one fixing ring 114. Specifically, a width of the third connecting piece 1176 is 0.8-1.2 mm, and is preferably 1 mm.

By above arrangement, the first fixing ring group 11941 has a swing range greater than that of the second fixing ring group 11942, so that a portion of the middle mounting portion 1194 inserting into the mouth of the use has a large swing range, which improves the comfort of the user and improve s the user satisfaction.

In some embodiments of the brush head body 119 of the present disclosure, the plurality of fixing rings 114 of the second fixing ring group 11942 are sequentially disposed in the first direction L of the brush neck portion 1191. Any two adjacent fixing rings 114 of the second fixing ring group 11942 share a side wall thereof. By above arrangement, more fixing rings 114 are allowed to be mounted in a limited space, which increases the area ratio of the bristle bundles 112, improves the structural strength of the middle mounting portion 1194 itself, improves the overall vibration intensity, and ensures the cleaning effect of the bristle bundles 112.

In some embodiments of the brush head body 119 of the present disclosure, each of the side mounting portions 1195 comprises the fixing rings 114 sequentially disposed in the first direction L. For instance, as shown in FIG. 3, each of the side mounting portions 1195 comprises the fixing rings 114, and the fixing rings 114 of any one of the side mounting portions 1195 are sequentially disposed in the first direction L, and corresponding bristle bundles 112 are respectively mounted in the fixing rings 114 of the side mounting portions 1195, and the corresponding bristle bundles 112 are configured for cleaning the teeth. Therefore, the cleaning efficiency of the bristle bundles 112 is improved and the user satisfaction is improved.

In some embodiments of the brush head body 119 of the present disclosure, at least part of adjacent fixing rings 114 of at least one of the two side mounting portions 1195 share a side wall thereof. By above arrangement, more fixing rings 114 are allowed to be defined in the limited space of the side mounting portions, which increases an area ratio of the bristle bundles 112 on the side mounting portions 1195, improves the structural strength of the side mounting portions 1195, maintains the overall vibration intensity, and improves the reliability of the brush head body 119.

It should be noted that adjacent fixing rings 114 of the side mounting portions 1195 may be connected through other connecting pieces, so that the fixing rings 114 of the side mounting portions 1195 are independent pieces, making the swing ranges of the bristle bundles 112 on the side mounting portions 1195 being large. Therefore, the bristle bundles 112 on the side mounting portions 1195 are able to clean a junction between the gums and the teeth and innermost ends of the teeth, bringing a good cleaning effect.

In some embodiments of the brush head body 119 of the present disclosure, at least one of the two side mounting portions 1195 comprises portions disposed at intervals. The portions thereof comprise corresponding fixing rings 114, a first one of the portions thereof is connected to the brush neck portion 1191, and a second one of the portions thereof is connected to the middle mounting portion 1194 through corresponding first connecting piece.

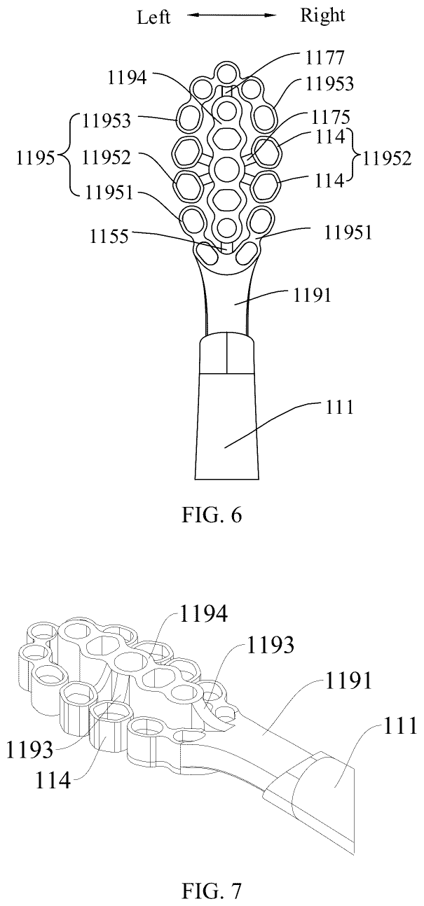

For instance, as shown in FIG. 6, at least one of the side mounting portions 1195 comprises the portions spaced apart in the first direction L, and each of the portion thereof comprises one or more fixing rings 114. The first one of the portions close to the brush neck portion 1191 is connected to the brush neck portion 1191, and a second one of the portions thereof is connected to the middle mounting portion 1194 through the first connecting pieces 1174. As a result, the portions of the at least one of the side mounting portions 1195 are independent pieces with respect to each other, and may have different freedom degrees, which realizes a flexible layout of the brush head body 119.

In some embodiments of the brush head body 119 of the present disclosure, at least one of the two side mounting portions 1195 comprises a first portion 11951, a second portion 11952, and a third portion 111953. The first portion 11951, the second portion 11952 and the third portion 11953 are disposed at intervals. The first portion is connected to the brush neck portion 1191. The first portion 11951 comprises at least one fixing ring 114. The second portion 11952 comprises at least one fixing ring 114. The at least one fixing ring 114 of the second portion 11952 is connected to the middle mounting portion 1194. The third portion 11953 comprises the fixing rings 114, any two adjacent fixing rings 114 of third portion 11953 share a side wall thereof. The third portion 11953 is connected to the middle mounting portion 1194.

For instance, as shown in FIG. 6, the at least one of the two side mounting portions 1195 comprise the first portion 11951, the second portion 11952, and the third portion 111953. The first portion 11951, the second portion 11952 and the third portion 11953 are disposed at intervals in the first direction L. The first portion is connected to the brush neck portion 1191. The first portion 11951 comprises one or more fixing ring 114. The second portion 11952 is close to corresponding middle portions of the middle mounting portion 1194 in the first direction L, and the second portion 11952 comprises one or more fixing rings 114. The one or more fixing ring 114 of the second portion 11952 is connected to the corresponding middle portion of the middle mounting portion 1194 in the first direction L through corresponding one or more first connecting pieces 1174. The third portion 11953 is close to the one end of the middle mounting portion away from the brush neck portion 1191, and the third portion 11953 comprises the fixing rings 114. The fixing rings of the third portion 11953 are disposed sequentially in the first direction L, and any two adjacent fixing rings 114 of third portion 11953. share a side wall thereof. The third portion 11953 is connected to the middle mounting portion 1194.

It is understood that by dividing the at least one of the side mounting portions 1195 into the first portion 11951, the second portion 11952, and the third portion 11953, and the first portion 11951, the second portion 11952, and the third portion 11953 are spaced apart from each other, so that the first portion 11951, the second portion 11952, and the third portion 11953 have higher freedom degrees, enabling the bristle bundles 112 on the second portion 11952 and the third portion 11953 have a larger swing range, thereby reducing damages to the gums and enamel of the user by the bristle bundles 112. Further, each two adjacent fixing rings 114 of the third portion 11953 share the side wall thereof, which avoids excessive swing ranges of the bristle bundles 112 on the third portion 11953, thereby improving the rationality of the design of the brush head body 119.

In some embodiments of the brush head body 119 of the present disclosure, the second portion 11952 comprises the fixing rings 114. The fixing rings 114 of the second portion 11952 are spaced apart. Each of the fixing rings 114 of the second portion 11952 is connected to the middle mounting portion 1194.

For instance, as shown in FIG. 6, the second portion 11952 comprises the fixing rings 114, the fixing rings 114 of the second portion 11952 are spaced apart in the first direction L, and the fixing rings 114 of the second portion 11952 are connected to the middle mounting portion 1194. Each of the fixing rings 114 of the second portion 11952 and the middle mounting portion 1194 share a side wall thereof to reduce a force arm between each of the fixing rings 114 of the second portion 11952 and the middle mounting portion 1194, reduce an impact of the second portion 11952 on the middle mounting portion 1194, and improves the structural strength of the middle mounting portion 1194. Alternatively, the fixing rings 114 of the second portion 11952 are connected to the middle mounting portion 1194 through the corresponding first connecting pieces 1174 to increase the swing range of the fixing rings 114 of the second portion. Thus, a flexible layout of the second portion 11952 is realized, which improves the practicality of the brush head body 119.

In some embodiments of the brush head body of the present disclosure, the two side mounting portions comprise first portions, second portions, and third portions. The third portions of the two side mounting portions 1195 are connected and are connected to the middle mounting portion 1194 through a fourth connecting piece. For instance, as shown in FIG. 6, ends of the two third portions 11953 away from the brush plate 1192 are connected to each other into a whole. The fourth connecting piece 1177 is configured to connect one of the fixing rings 114 of the two third portions 11953 to the one end of the middle mounting portion 1194 away from the brush neck portion 1191, so that the two third portions 11953 are connected to the middle mounting portion 1194 through the fourth connecting piece 1177. Specifically, a width of the fourth connecting member 1177 is 0.8-1.2 mm and is preferably 1 mm. Thus, the structural complexity of the brush head body 119 is reduced, which reduces processing difficulty and cost, and improves an overall structural strength of the brush head body 119.

In some embodiments of the brush head body of the present disclosure, as shown in FIG. 7, reinforcing plates 1193 are disposed on the brush plate 1192. One of the reinforcing plates 1193 is connected between the brush neck portion 1191 and the brush plate 1192, and the other reinforcing plates 1193 are respectively connected between the middle mounting portion 1194 and the side mounting portions 1195. Thus, the mounting stability and structural strength of the brush plate 1192 are improved.

Further, the reinforcing plates 1193 are integrated with corresponding connecting pieces. Specifically, as shown in FIG. 7, the one of the reinforcing plates 1193 connected between the middle mounting portion 1194 and the brush neck portion 1191 is integrally formed with the second connecting piece 1175. Therefore, the structural complexity of the brush plate 1192 is reduced, which reduces the processing difficulty and processing cost.

In some embodiments of the brush head body of the present disclosure, the one end of the middle mounting portion 1194 facing the brush neck portion 1191 is connected to the brush neck portion 1191 through the second connecting piece 1175. A rigidity of the brush neck portion 1191 is greater than a rigidity of the second connecting piece 1175; and/or the rigidity of the second connecting piece 1175 is greater than a rigidity of each of the first connecting pieces 1174.

For instance, as shown in FIG. 6, the one end of the middle mounting portion 1194 facing the brush neck portion 1191 is spaced apart from the brush neck portion 1191 and is connected to the brush neck portion 1191 through the second connecting piece 1175, and parts of the side mounting portions 1195 are connected to the middle mounting portion 1194 through the first connecting pieces 1175. The rigidity of the brush neck portion 1191 is greater than the rigidity of the second connecting piece 1175, and the rigidity of the second connecting piece 1175 is greater than the rigidity of each of the first connecting pieces 1174. In this way, when the middle mounting portion 1194 deforms or moves with respect to the brush neck portion 1191, a shape of the brush neck portion 1191 always remains unchanged. When the parts of the side mounting portions 1195 connected to the middle mounting portion 1194 deform or move with respect to the middle mounting portion 1194, the shape of the middle mounting portion 1194 remains unchanged.

By above arrangement, the middle mounting portion 1194 and the parts of the side mounting portions 1195 connected to the middle mounting portion 1194 are able to deform to different extents, so that the brush plate 1192 fits the teeth closely, thereby improving the cleaning efficiency and improving the comfort and the user satisfaction.

It should be noted that the brush neck portion 1191 is configured to have a thickness greater than a thickness of the second connecting piece 1175, and the second connecting piece 1175 is configured to have a thickness greater than a thickness of each of the first connecting pieces 1174. Alternatively, the brush neck portion 1191 is configured to have a width greater than the width of the second connecting piece 1175, and the second connecting piece 1175 is configured to have the width greater than the width of each of the first connecting pieces 1174. Of course, any method that realizes rigidity differences thereof is within the scope of the present disclosure.

The present disclosure further provided a brush head 11.

As shown in FIGS. 1 and 2, the brush head 11 comprises the brush head body 119 according to any one of the embodiments mentioned above and an elastic structure 113 wrapped around outer peripheral walls of the fixing rings 114. It should be noted that the elastic structure 113 is made from elastic material such as rubber. The elastic structure 113 is configured to cover an outer side of the brush head body 119 to separate the brush head body 119 from the oral cavity to prevent the brush head 11 from being too hard to case discomfort.

In the embodiment of the brush head 11 of the present disclosure, the thickness of the fixing rings 114 of the middle mounting portion 1194 in the third direction Y is greater than the thickness of the fixing rings 114 of the two side mounting portions 1195, so that the bristle fixing holes 114A on the middle mounting portion 1194 have a large depth, which increases the contact area between the middle mounting portion 1194 and the corresponding bristle bundles 112, thereby improving the binding force of the middle mounting portion 1194 on the bristle bundles 112, making the bristle bundles 112 fixed on the middle mounting portion 1194 difficult to pull off and having high vibration intensity. Therefore, the mounting stability and cleaning efficiency of the bristle bundles 112 is improved, the reliability of the brush head body is improved, and overall performance of the brush head is improved.

In some embodiments of the brush head 11 of the present disclosure, a thickness of the elastic structure gradually increases from an outer side wall of the brush head 11 to a middle portion of the brush head 11. By such arrangement, the thickness of the elastic structure 113 on two sides of the brush head 11 is less than the thickness of the elastic structure 113 in a middle portion thereof. Therefore, portions of the brush head 11 that often contact an inner wall of the oral cavity are thin, which reduces the foreign body sensation brought to the user. Further, a surface of the elastic structure 113 is smoothly transited, which makes the brush head smooth, avoids puncture wounds causes by sharp corner that should have been there, and improves the user comfort.

In some embodiments of the brush head 11 of the present disclosure, as shown in FIGS. 1 and 2, the elastic structure completely wraps a peripheral side of the brush head body 119 and a back side of the brush head body 119 away from the bristle bundles 112. By such arrangement, the peripheral side and the back side of the brush head 11 are elastic, which prevent the brush head body 119 from damaging the teeth.

In some embodiments of the brush head 11 of the present disclosure, in the first direction L, a minimum distance between the one end of the middle mounting portion 1194 away from the brush neck portion 1191 and an outer peripheral wall of the elastic structure 113 is 1-4 mm. For instance, the minimum distance between the one end of the middle mounting portion 1194 away from the brush neck portion 1191 and the outer peripheral wall of the elastic structure 113 is 2 mm. Alternatively, the minimum distance between the one end of the middle mounting portion 1194 away from the brush neck portion 1191 and the outer peripheral wall of the elastic structure 113 is 2.5 mm. Alternatively, the minimum distance between the one end of the middle mounting portion 1194 away from the brush neck portion 1191 and the outer peripheral wall of the elastic structure 113 is 3 mm, which is not limited thereto. Therefore, one end of the brush head 11 inserting into the oral cavity is covered with the elastic structure 113 of sufficient thickness. At the same time, the elastic structure 113 is located lower than an end face where the bristle fixing holes 114A are located, so as to prevent rubber liquid from flowing to the bristle bundles during molding of the elastic structure 113. The elastic structure 113 covers the fixing rings 114 and the middle mounting portion 1194, so that connecting ribs connecting the fixing rings 114 and the middle mounting portion 1194 are not exposed, thereby improving the integrity of the surface of the elastic structure 113 and avoiding dirt and grime. It is understood that completely covering the fixing rings 114 and the middle mounting portion 1194 protects some of the fixing rings 114 that thin and deformable, protects the middle mounting portion 1194, and avoids a problem of broken of the middle mounting portion 1194 caused by repeated deformations.

The present disclosure further provides a toothbrush 1.

As shown in FIGS. 1 and 2, the toothbrush 1 comprises the brush head 11 according to any one of the embodiments mentioned above.

In the embodiment of the toothbrush 1 of the present disclosure, the thickness of the fixing rings 114 of the middle mounting portion 1194 in the third direction Y is greater than the thickness of the fixing rings 114 of the two side mounting portions 1195, so that the bristle fixing holes 114A on the middle mounting portion 1194 have the large depth, which increases the contact area between the middle mounting portion 1194 and the corresponding bristle bundles 112, thereby improving the binding force of the middle mounting portion 1194 on the bristle bundles 112, making the bristle bundles 112 fixed on the middle mounting portion 1194 difficult to pull off and having high vibration intensity. Therefore, the mounting stability and cleaning efficiency of the bristle bundles 112 is improved, the reliability of the brush head body is improved, the overall performance of the brush head 11 is improved, and competitiveness of the toothbrush 1 is improved.

It should be noted that the toothbrush 1 in the embodiments of the present disclosure may be an ordinary toothbrush or an electric toothbrush, which is not limited thereto.

A brush head body 119 of the embodiments of the present disclosure is illustrated with reference to the drawings.

It should be noted that a first direction L is an up-down direction shown in FIG. 2, a second direction X is a left-right direction shown in FIG. 2, and a third direction Y is a front-rear direction shown in FIG. 1. The first direction L, the second direction X, and the third direction Y are perpendicular to each other.

As shown in FIGS. 1-7, the brush head body 119 of the embodiments of the present disclosure comprises a brush neck portion 1191 and a brush plate 1192. The brush neck portion 1191 extends in the first direction L. The brush plate 1192 is disposed on the brush neck portion 1191. The brush plate 1192 comprises a middle mounting portion 1194 and two side mounting portions 1195. The two side mounting portions 1195 are respectively disposed on two sides of the middle mounting portion 1194 in the second direction X. At least one of the middle mounting portion 1194 and the two side mounting portions 1195 is connected to the brush neck portion 1191. A rigidity of one of the two side mounting portions adjacent to the brush neck portion 1191 and/or a rigidity of the middle mounting portion 1194 is less than a rigidity of the brush neck portion 1191. The middle mounting portion 1194 and the two side mounting portions 1195 comprise fixing rings 114 configured to mount bristle bundles 112. The bristle bundles extend in the third direction Y. The middle mounting portion 1194 is connected to the brush neck portion 1191, and/or the middle mounting portion is connected to at least one of the two side mounting portions. The middle mounting portion 1194 is capable of swinging and/or deforming with respect to the brush neck portion 1191. The first direction L, the second direction X, and the third direction Y are perpendicular to each other.

Therefore, the bristle bundles 112 located in a middle area of the brush plate 1192 in the second direction X are movable, which reduces the probability of resonance between the bristle bundles 112 and the brush plate 1192, reduces damage to the gums and enamel of the user, and improves the comfort of the user.

For instance, as shown in FIGS. 1-3, the brush head body 119 comprises the brush neck portion 1191 and the brush plate 1192. The brush neck portion 1191 extends in the first direction L. A first end of the brush neck portion 1191 is connected to the brush rod 111. The brush rod 111 is configured as a round rod, a square rod, or other structures that are easy for the user to hold. A second end of the brush neck portion 1191 is connected to the brush plate 1192. The brush plate 1192 is disposed perpendicularly to the third direction Y. The brush plate 1192 comprises the middle mounting portion 1194 and the two side mounting portions 1195. In the second direction X, the two side mounting portions 1195 are respectively disposed on the two sides of the middle mounting portion 1194.

The middle mounting portion 1194 and the two side mounting portions 1195 comprises the fixing rings 114. The fixing rings 114 are disposed sequentially. The fixing rings 114 are configured to mount bristle bundles 112. The bristle bundles 112 extend in the third direction Y to protrude from a side wall of the brush plate 1192, and are configured to cleaning the oral cavity.

At least one of the middle mounting portion 1194 and the two side mounting portions 1195 is connected to the brush neck portion 1191. The rigidity of the one of the two side mounting portions adjacent to the brush neck portion 1191 and/or the rigidity of the middle mounting portion 1194 is less than the rigidity of the brush neck portion 1191.

Specifically, at least one of the side mounting portion 1195 is connected to the brush neck portion 1191, and the rigidity of the side mounting portions 1195 is less than the rigidity of the brush neck portion 1191. Alternatively, the middle mounting portion 1194 is connected to the brush neck portion 1191, and the rigidity of the middle mounting portion 1194 is less than the rigidity of the brush neck portion 1191. Alternatively, the at least one of the side mounting portions 1195 and the middle mounting portion 1194 are connected to the brush neck portion 1191, and the rigidity of the side mounting portions 1195 and the rigidity of the middle mounting portion 1194 are less than the rigidity of the brush neck portion 1191, which are not limited thereto. In this way, when the brush plate 1192 deforms or moves, the shape of the brush neck portion 1191 always remains unchanged to provide stable support for the brush plate 1192.

Furthermore, the middle mounting portion 1194 is connected to the brush neck portion 1191, and/or the middle mounting portion 1194 is connected to at least one of the two side mounting portions 1195. The middle mounting portion 1194 is capable of swinging and/or deforming with respect to the brush neck portion 1191. Specifically, at least one of the side mounting portions 1195 is connected to the brush neck portion 1191, then the middle mounting portion 1194 is connected to the brush plate 1192 so as to be connected to the brush neck portion 1191, and the middle mounting portion 1194 is capable of swinging or deforming with respect to the brush neck portion 1191. Alternatively, the middle mounting portion 1194 is connected to the brush neck portion 1191, and the middle mounting portion 1194 is capable of swinging or deforming with respect to the brush neck portion 1191. Alternatively, the middle mounting portion 1194 is connected to the brush neck portion 1191 and is capable of swinging or deforming with respect to the brush neck portion 1191, and the brush plate 1192 is connected to the middle mounting portion 1194, which is not limited thereto.

By such arrangement, the bristle bundles 112 located in the middle area of the brush plate 1192 in the second direction X are movable, which reduce the probability of resonance between the bristle bundles 112 and the brush plate 1192.

In the brush head body of the embodiment of the present disclosure, the middle mounting portion 1194 is disposed between the two side mounting portions 1195, and the middle mounting portion 1194 is swingable with respect to the brush neck portion 1191, so that the bristle bundles 112 located in the middle area of the brush plate 1192 in the second direction X are movable, which reduces the probability of resonance between the bristle bundles 112 and the brush plate 1192. Further, in conjunction with the shock absorption function of the brush head body 119, for instance, the brush head body 119 is covered with the elastic structure 113, damages to the gums and enamel of the user are reduced, and the user comfort is improved.

In some embodiments of the brush head body 119 of the present disclosure, one end of the middle mounting portion 1194 facing the brush neck portion 1191 is spaced apart from the brush neck portion 1191, and the middle mounting portion 1194 is connected to at least one of the two side mounting portions 1195 through at least one first connecting piece 1174.

For instance, as shown in FIG. 3, the two side mounting portions 1195 are connected to the brush neck portion 1191, and the one end of the middle mounting portion 1194 toward the brush neck portion 1191 is spaced apart from the brush neck portion 1191. The middle mounting portion 1194 is connected to at least one of the side mounting portions through the at least one first connecting piece 1174. A width of the at least one first connecting piece 1174 is relatively small, so that the middle mounting portion 1194 is swingable with respect to at least one of the side mounting portions 1195, and the middle mounting portion 1194 is swingable with respect to the brush neck portion 1191. It should be noted that the width of the at least one first connecting piece 1174 is 0.8-1.2 mm, and is preferably 1 mm.

Specifically, the middle mounting portion 1194 is connected to only one of the side mounting portions 1195 through one first connecting piece 1174, so that the swing range of the middle mounting portion 1194 is larger and the brush plate 1192 has a higher freedom degree and a stronger shock absorption effect; Alternatively, the middle mounting portion 1194 is connected to the two side mounting portions 1195 through two first connecting pieces 1174 to increase a connection strength between the side mounting portions 1195 and the middle mounting portion 1194, so that the brush plate 1192 is not easily deformed.

By such arrangement, an integrity of the brush head body 119 is improved, which reduces the number of parts of the brush head body 119 and facilitate integrated molding of the brush head body 119. In a process of placing the brush head body 119 into a mold to install the elastic structure 113, there is no need to separately fix the middle mounting portion 1194 and the side mounting portions 1195, which reduces a difficulty of processing.

In some embodiments of the brush head body 119 of the present disclosure, the middle mounting portion 1194 is connected to the two side mounting portions 1195 through the first connecting pieces 1174 respectively disposed on middle portions of two opposite side walls of the middle mounting portion 1194.

For instance, as shown in FIG. 3, the first connecting pieces 1174 are disposed the middle portions of the middle mounting portion 1194 in the first direction L. Each of the first connecting pieces 1174 is configured to connect a side wall of the middle mounting portion 1194 facing a corresponding side mounting portion 1195 to a side wall of the corresponding side mounting portion 1195. In this way, distances between the two ends of the middle mounting portion 1194 in the first direction L respectively to first connecting pieces 1174 are equal, so that swing ranges of the two ends of the middle mounting portion 1194 along the first direction L are the same. Therefore, it avoids the swing ranges of the two ends of the middle mounting portion 1194 in the first direction L being too large or too small, which improves rationality of a design of the brush head body 119.

In some embodiments of the brush head body 119 of the present disclosure, the one end of the middle mounting portion 1194 facing the brush neck portion 1191 is connected to the brush neck portion 1191 through a second connecting piece 1175. For instance, as shown in FIG. 5, the two side mounting portions 1195 are connected to the brush neck portion 1191, and the one end of the middle mounting portion 1194 facing the brush neck portion 1191 is connected to the brush neck portion 1191 through the second connecting piece 1175. A width of the second connecting piece 1175 is relatively small, so that the middle mounting portion 1194 is swingable with respect to the brush neck portion 1191. Specifically, the width of the second connecting piece 1175 is 0.8-1.2 mm, and is preferably 1 mm.

By such arrangement, the side mounting portions 1195 and the middle mounting portion 1194 are separated from each other. The side mounting portions 1195 and the middle mounting portion 1194 are swingable, which reduces the damage of the bristle bundle 112 to the gums and enamel of the user, reduces the structural complexity of the brush head body 119, and improves the structural strength of the brush head body 119.

Furthermore, as shown in FIG. 5, one end of the middle mounting portion 1194 away from the brush neck portion 1191 is configured as a free end. By such arrangement, one end of the brush plate 1192 away from the brush neck portion 1191 has a greater freedom degree, which increase the swing range of corresponding bristle bundles 112, which reduces the foreign body sensation brought to the user and improves the user satisfaction.

In some embodiments of the brush head body 119 of the present disclosure, the middle mounting portion 1194 comprises a first fixing ring group 11941 and a second fixing ring group 11942. The first fixing ring group 11941 is located at an end portion of the middle mounting portion 1194 and is connected to the second fixing ring group 11942 through a third connecting piece 1176. The first fixing ring group 11941 is capable of swinging with respect to the second fixing ring group 11942. The first fixing ring group 11941 comprises at least one fixing ring 114. The second fixing ring group 11942 comprises a plurality of fixing rings 114.

For instance, as shown in FIG. 5, the middle mounting portion 1194 comprises the first fixing ring group 11941 and the second fixing ring group 11942. The second fixing ring group 11942 is connected to the brush neck portion 1191 through the second connecting piece 1175, the second fixing ring group 11942 is swingable with respect to the brush neck portion 1191, and the second fixing ring group 11942 comprises the plurality of fixing rings 114. The first fixing ring group 11941 is disposed on one end of the middle mounting portion 1194 away from the brush neck portion 1191. The first fixing ring group 11941 is connected to one end, away from the brush neck portion 1191, of the second fixing ring group 11942 (i.e., a free end of the second fixing ring group) through the third connecting piece 1176., so that the first fixing ring group 11941 is swingable with respect to the second fixing ring group 11942. The first fixing ring group 11941 comprises the at least one fixing ring 114. It should be noted that a width of the third connecting piece 1176 is 0.8-1.2 mm, and is preferably 1 mm.

By such arrangement, the first fixing ring group 11941 has a swing range greater than that of the second fixing ring group 11942, so that a portion of the middle mounting portion 1194 inserting into the mouth of the use has a large swing range, which improves the comfort of the user and improve s the user satisfaction.

In some embodiments of the brush head body 119 of the present disclosure, the plurality of fixing rings 114 of the second fixing ring group 11942 are sequentially disposed in the first direction L. Any two adjacent fixing rings 114 of the second fixing ring group 11942 share a side wall thereof. By such arrangement, more fixing rings 114 are allowed to be mounted in a limited space of the second fixing ring group 11942, which increases the area ratio of the bristle bundles 112, improves the structural strength of the middle mounting portion 1194 itself, improves the overall vibration intensity, and ensures the cleaning effect of the bristle bundles 112.

In some embodiments of the brush head body 119 of the present disclosure, as shown in FIG. 3, each of the side mounting portions 1195 comprises the fixing rings 114 sequentially disposed in the first direction L. For instance, as shown in FIG. 3, each of the side mounting portions 1195 extends linearly or obliquely in the first direction L, each of the side mounting portions 1195 comprises the fixing rings 114, the fixing rings 114 of any one of the side mounting portions 1195 are sequentially disposed along the first direction L, and side walls of each two adjacent fixing rings 114 facing each other, of the side mounting portions 1195 are connected as a whole. Corresponding bristle bundles 112 are respectively mounted in the fixing rings 114 of the side mounting portions 1195, and the corresponding bristle bundles 112 are configured for cleaning the teeth. Therefore, the cleaning efficiency of the bristle bundles 112 is improved and the user satisfaction is improved.

In some embodiments of the brush head body 119 of the present disclosure, at least part of adjacent fixing rings 114 of at least one of the two side mounting portions 1195 share a side wall thereof. By above arrangement, more fixing rings 114 are allowed to be defined in the limited space of the side mounting portions, which increases an area ratio of the bristle bundles 112 on the side mounting portions 1195, improves the structural strength of the side mounting portions 1195, maintains the overall vibration intensity, and improves the reliability of the brush head body 119. Of course, adjacent fixing rings 114 of the side mounting portions 1195 may be connected through other connecting pieces, so that the fixing rings 114 of the side mounting portions 1195 are independent pieces, making the swing ranges of the bristle bundles 112 on the side mounting portions 1195 being large. Therefore, the bristle bundles 112 on the side mounting portions 1195 are able to clean a junction between the gums and the teeth and innermost ends of the teeth, bringing a good cleaning effect.

In some embodiments of the brush head body 119 of the present disclosure, at least one of the two side mounting portions 1195 comprises portions disposed at intervals. The portions thereof comprise corresponding fixing rings 114, a first one of the portions thereof is connected to the brush neck portion 1191, and a second one of the portions thereof is connected to the middle mounting portion 1194 through corresponding first connecting piece.

For instance, as shown in FIG. 6, at least one of the side mounting portions 1195 comprises the portions spaced apart in the first direction L, and each of the portion thereof comprises one or more fixing rings 114. The first one of the portions close to the brush neck portion 1191 is connected to the brush neck portion 1191, and a second one of the portions thereof is connected to the middle mounting portion 1194 through the first connecting pieces 1174. As a result, the portions of the at least one of the side mounting portions 1195 are independent pieces with respect to each other, and may have different freedom degrees, which realizes a flexible layout of the brush head body 119.

In some embodiments of the brush head body 119 of the present disclosure, at least one of the two side mounting portions 1195 comprises a first portion 11951, a second portion 11952, and a third portion 111953. The first portion 11951, the second portion 11952 and the third portion 11953 are disposed at intervals. The first portion is connected to the brush neck portion 1191. The first portion 11951 comprises at least one fixing ring 114. The second portion 11952 comprises at least one fixing ring 114. The at least one fixing ring 114 of the second portion 11952 is connected to the middle mounting portion 1194. The third portion 11953 comprises the fixing rings 114, any two adjacent fixing rings 114 of third portion 11953 share a side wall thereof. The third portion 11953 is connected to the middle mounting portion 1194.

For instance, as shown in FIG. 6, the at least one of the two side mounting portions 1195 comprises the first portion 11951, the second portion 11952, and the third portion 111953. The first portion 11951, the second portion 11952 and the third portion 11953 are disposed at intervals in the first direction L. The first portion is connected to the brush neck portion 1191. The first portion 11951 comprises one or more fixing ring 114. The second portion 11952 is close to corresponding middle portions of the middle mounting portion 1194 in the first direction L, and the second portion 11952 comprises one or more fixing rings 114. The one or more fixing ring 114 of the second portion 11952 is connected to the corresponding middle portion of the middle mounting portion 1194 in the first direction L through corresponding one or more first connecting pieces 1174. The third portion 11953 is close to the one end of the middle mounting portion away from the brush neck portion 1191, and the third portion 11953 comprises the fixing rings 114. The fixing rings of the third portion 11953 are disposed sequentially in the first direction L, and any two adjacent fixing rings 114 of third portion 11953. share a side wall thereof. The third portion 11953 is connected to the middle mounting portion 1194.

It is understood that by dividing the at least one of the side mounting portions 1195 into the first portion 11951, the second portion 11952, and the third portion 11953, and the first portion 11951, the second portion 11952, and the third portion 11953 are spaced apart from each other, so that the first portion 11951, the second portion 11952, and the third portion 11953 have higher freedom degrees, enabling the bristle bundles 112 on the second portion 11952 and the third portion 11953 have a larger swing range, thereby reducing damages to the gums and enamel of the user by the bristle bundles 112. Further, each two adjacent fixing rings 114 of the third portion 11953 share the side wall thereof, which avoids excessive swing ranges of the bristle bundles 112 on the third portion 11953, thereby improving the rationality of the design of the brush head body 119.

In some embodiments of the brush head body 119 of the present disclosure, the second portion 11952 comprises the fixing rings 114. The fixing rings 114 of the second portion 11952 are spaced apart. Each of the fixing rings 114 of the second portion 11952 is connected to the middle mounting portion 1194.

For instance, as shown in FIG. 6, the second portion 11952 comprises the fixing rings 114, the fixing rings 114 of the second portion 11952 are spaced apart in the first direction L, and the fixing rings 114 of the second portion 11952 are connected to the middle mounting portion 1194. Each of the fixing rings 114 of the second portion 11952 and the middle mounting portion 1194 share a side wall thereof to reduce a force arm between each of the fixing rings 114 of the second portion 11952 and the middle mounting portion 1194, reduce an impact of the second portion 11952 on the middle mounting portion 1194, and improves the structural strength of the middle mounting portion 1194. Alternatively, the fixing rings 114 of the second portion 11952 are connected to the middle mounting portion 1194 through the corresponding first connecting pieces 1174 to increase the swing range of the fixing rings 114 of the second portion. Thus, a flexible layout of the second portion 11952 is realized, which improves the practicality of the brush head body 119.

In some embodiments of the brush head body of the present disclosure, the two side mounting portions comprise first portions, second portions, and third portions. The third portions of the two side mounting portions 1195 are connected and are connected to the middle mounting portion 1194 through a fourth connecting piece. For instance, as shown in FIG. 6, ends of the two third portions 11953 away from the brush plate 1192 are connected to each other into a whole. The fourth connecting piece 1177 is configured to connect one of the fixing rings 114 of the two third portions 11953 to the one end of the middle mounting portion 1194 away from the brush neck portion 1191, so that the two third portions 11953 are connected to the middle mounting portion 1194 through the fourth connecting piece 1177. Specifically, a width of the fourth connecting member 1177 is 0.8-1.2 mm and is preferably 1 mm. Thus, the structural complexity of the brush head body 119 is reduced, which reduces processing difficulty and cost, and improves an overall structural strength of the brush head body 119.

In some embodiments of the brush head body 119 of the present disclosure, as shown in FIG. 3, ends of the two side mounting portions 1195 away from the brush head 11 are connected to surround the end portion of the middle mounting portion 1194. By such arrangement, the two side mounting portions 1195 are connected as a whole, which reduces the difficulty of manufacturing, improves the structural strength of the side mounting portions 1195, and improves the overall structural strength of the brush head body 119.

In some embodiments of the brush head body 119 of the present disclosure, the fixing rings 114 of the middle mounting portion 1194 are sequentially disposed in the first direction L.

For instance, as shown in FIG. 3, the middle mounting portion 1194 comprises a plurality of fixing rings 114. The plurality of fixing rings 114 of the middle mounting portion 1194 are disposed sequentially in the first direction L, and corresponding bristle bundles 112 are respectively mounted in the plurality of fixing rings 114 of the middle mounting portion 1194, so that the corresponding bristle bundles 112 are disposed sequentially in the first direction L. The bristle bundles 112 are configured to jointly clean the oral cavity, so that the cleaning efficiency of the oral cavity is improved by the bristle bundles 112. Thus, the practicality of the brush head body 119 is improved.

In some embodiments of the brush head body 119 of the present disclosure, the brush head body 119 comprises recessed portions. Each of the recessed portions is formed at a connection portion of each two fixing rings 114 connected to each other. In the second direction X, each of the recessed portions of the middle mounting portion 1194 directly faces an outer peripheral wall of a corresponding fixing ring of one of the two side mounting portions 1195, and/or each of the recessed portions of the two side mounting portions 1195 directly faces an outer peripheral wall of a corresponding fixing ring of the middle mounting portion 1194.

For instance, as shown in FIG. 1, the fixing rings 114 are sequentially disposed in the first direction L. Each of the recessed portions is formed at the connection portion of each two fixing rings 114, and the recessed portions are configured to be recessed inward in the second direction X. In the second direction, each of the recessed portions of the middle mounting portion 1194 directly faces the outer peripheral wall of the corresponding fixing ring of one of the two side mounting portions 1195. Alternatively, each of the recessed portions of the two side mounting portions 1195 directly faces the outer peripheral wall of the corresponding fixing ring 114 of the middle mounting portion 1194. Alternatively, each of the recessed portions of the middle mounting portion 1194 directly faces the outer peripheral wall of the corresponding fixing ring of the one of the two side mounting portions 1195, and each of the recessed portions of the two side mounting portions 1195 directly faces the outer peripheral wall of the corresponding fixing ring 114 of the middle mounting portion 1194. However, the present disclosure is not limited thereto. In this way, gaps between the side mounting portions 1195 and the middle mounting portions 1194 form a wavy shape, which improves an area utilization of the brush plate 1192, so that more fixing rings 114 are allowed to be defined in per unit area, and more bristle bundles 112 are mounted in the fixing rings. In addition, the elastic structure 113 fills the gaps between the side mounting portions 1195 and the middle mounting portion 1194, which improves the mounting stability of the elastic structure 113 and improves the practicality of the brush head body 119.

In some embodiments of the brush head body 119 of the present disclosure, the fixing rings 114 comprise bristle fixing holes 114A, and a depth of each of the bristle fixing holes 114A of the side mounting portions 1195 is less than a depth of each of the bristle fixing holes 114A of the middle mounting portion 1194. For instance, as shown in FIGS. 1-3, each of the fixing rings 114 comprises a corresponding bristle fixing hole 114A. Each of the bristle fixing holes 114A runs through a corresponding fixing ring 114 in the third direction Y, so that the bristle fixing holes are through holes. A fixing end of each of the bristle bundles 112 extend into a corresponding bristle fixing hole 114A from a first end of the corresponding bristle fixing hole 114A and extend to a second end of the corresponding bristle fixing hole 114A. The fixing end of each of the bristle bundles 112 is melted to form a head portion 1122. There are many head portions 1122, and each of the head portions 1122 is configured to fix a corresponding bristle bundle 112 on a corresponding fixing ring 114.

A thickness of each of the side mounting portions 1195 in the third direction Y is less than a thickness of the middle mounting portion 1194 in the third direction Y, so that the depth of each of the bristle fixing holes 114A of the side mounting portions 1195 is less than the depth of each of the bristle fixing holes 114A of the middle mounting portion 1194, making the middle mounting portion 1194 have greater structural strength, improving a limiting effect of the middle mounting portion 1194 on the bristle bundles 112, and improving the cleaning effect of the bristle bundles 112 on the oral cavity. Thus, layout rationality of the brush head body 119 is improved.

In some embodiments of the brush head body 119 of the present disclosure, as shown in FIG. 7, reinforcing plates 1193 are disposed on the brush plate 1192. One of the reinforcing plates 1193 is connected between the brush neck portion 1191 and the brush plate 1192, and the other reinforcing plates 1193 are respectively connected between the middle mounting portion 1194 and the side mounting portions 1195. Thus, the mounting stability and structural strength of the brush plate 1192 are improved.

Furthermore, the reinforcing plates 1193 are integrated with corresponding connecting pieces. Specifically, as shown in FIG. 7, the one of the reinforcing plates 1193 connected between the middle mounting portion 1194 and the brush neck portion 1191 is integrally formed with the second connecting piece 1175. Therefore, the structural complexity of the brush plate 1192 is reduced, which reduces the processing difficulty and processing cost.

In some embodiments of the brush head body of the present disclosure, the one end of the middle mounting portion 1194 facing the brush neck portion 1191 is connected to the brush neck portion 1191 through the second connecting piece 1175. A rigidity of the brush neck portion 1191 is greater than a rigidity of the second connecting piece 1175; and/or the rigidity of the second connecting piece 1175 is greater than a rigidity of each of the first connecting pieces 1174.

For instance, as shown in FIG. 7, the one end of the middle mounting portion 1194 facing the brush neck portion 1191 is spaced apart from the brush neck portion 1191 and is connected to the brush neck portion 1191 through the second connecting piece 1175, and parts of the side mounting portions 1195 are connected to the middle mounting portion 1194 through the first connecting pieces 1175. The rigidity of the brush neck portion 1191 is greater than the rigidity of the second connecting piece 1175, and the rigidity of the second connecting piece 1175 is greater than the rigidity of each of the first connecting pieces 1174. In this way, when the middle mounting portion 1194 deforms or moves with respect to the brush neck portion 1191, a shape of the brush neck portion 1191 always remains unchanged. When the parts of the side mounting portions 1195 connected to the middle mounting portion 1194 deform or move with respect to the middle mounting portion 1194, the shape of the middle mounting portion 1194 remains unchanged.

By such arrangement, the middle mounting portion 1194 and the parts of the side mounting portions 1195 connected to the middle mounting portion 1194 are able to deform to different extents, so that the brush plate 1192 fits the teeth closely, thereby improving the cleaning efficiency and improving the comfort and the user satisfaction.

It should be noted that the brush neck portion 1191 is configured to have a thickness greater than a thickness of the second connecting piece 1175, and the second connecting piece 1175 is configured to have a thickness greater than a thickness of each of the first connecting pieces 1174. Alternatively, the brush neck portion 1191 is configured to have a width greater than the width of the second connecting piece 1175, and the second connecting piece 1175 is configured to have the width greater than the width of each of the first connecting pieces 1174. Of course, any method that realizes rigidity differences thereof is within the scope of the present disclosure.

The present disclosure further provided a brush head 11.

As shown in FIGS. 1 and 2, the brush head 11 comprises the brush head body 119 according to any one of the embodiments mentioned above and an elastic structure 113 wrapped around outer peripheral walls of the fixing rings 114. It should be noted that the elastic structure 113 is made from elastic material such as rubber. The elastic structure 113 is configured to cover an outer side of the brush head body 119 to separate the brush head body 119 from the oral cavity to prevent the brush head 11 from being too hard to cause discomfort.

In the brush head 11 of the embodiment of the present disclosure, the middle mounting portion 1194 is disposed between the two side mounting portions 1195, and the middle mounting portion 1194 is swingable with respect to the brush neck portion 1191, so that the bristle bundles 112 located in the middle area of the brush plate 1192 in the second direction X are movable, which reduces the probability of resonance between the bristle bundles 112 and the brush plate 1192. Further, in conjunction with the shock absorption function of the brush head body 119, for instance, the brush head body 119 is covered with the elastic structure 113, damages to the gums and enamel of the user are reduced, the user comfort is improved, and the overall performance of the brush head 11 is improved.

In some embodiments of the brush head 11 of the present disclosure, as shown in FIG. 1, a thickness of the elastic structure gradually increases from an outer side wall of the brush head 11 to a middle portion of the brush head 11. By such arrangement, the thickness of the elastic structure 113 on two sides of the brush head 11 is less than the thickness of the elastic structure 113 in a middle portion thereof. Therefore, portions of the brush head 11 that often contact an inner wall of the oral cavity are thin, which reduces the foreign body sensation brought to the user. Further, a surface of the elastic structure 113 is smoothly transited, which makes the brush head smooth, avoids puncture wounds causes by sharp corner that should have been there, and improves the user comfort.

In some embodiments of the brush head 11 of the present disclosure, as shown in FIGS. 1 and 2, the elastic structure completely wraps a peripheral side of the brush head body 119 and a back side of the brush head body 119 away from the bristle bundles 112. By such arrangement, the peripheral side and the back side of the brush head 11 are elastic, which prevent the brush head body 119 from damaging the teeth, thereby improving the user comfort and the user satisfaction.

In some embodiments of the brush head 11 of the present disclosure, in the first direction L, a minimum distance between the one end of the middle mounting portion 1194 away from the brush neck portion 1191 and an outer peripheral wall of the elastic structure 113 is 1-4 mm. For instance, the minimum distance between the one end of the middle mounting portion 1194 away from the brush neck portion 1191 and the outer peripheral wall of the elastic structure 113 is 2 mm. Alternatively, the minimum distance between the one end of the middle mounting portion 1194 away from the brush neck portion 1191 and the outer peripheral wall of the elastic structure 113 is 2.5 mm. Alternatively, the minimum distance between the one end of the middle mounting portion 1194 away from the brush neck portion 1191 and the outer peripheral wall of the elastic structure 113 is 3 mm, which is not limited thereto. Therefore, one end of the brush head 11 inserting into the oral cavity is covered with the elastic structure 113 of sufficient thickness, which improves the user comfort and the user satisfaction.

In some embodiments of the present disclosure, the elastic structure 113 completely wraps the connecting pieces disposed between the middle mounting portion 1194 and the side mounting portions 1195. In other embodiments of the present disclosure, the elastic structure 113 completely wraps a connecting piece disposed between the middle mounting portion 1194 and the brush neck portion 1191. In some embodiments of the present disclosure, the elastic structure 113 completely wraps the connecting between the side mounting portions 1195 and the brush neck portion 119. For instance, the connecting pieces between the middle mounting part 1194 and the side mounting part 1195 is the first connecting pieces 1174, and the connecting piece disposed between the middle mounting portion 1194 and the brush neck portion 1191 is the second connecting piece 1175 mentioned above. The connecting pieces disposed between the side mounting portions 1195 and the brush neck portion 1191 are fourth connecting pieces (not shown in the drawings). By using the elastic structure 113 to wrap the connecting pieces mentioned above, toughness of the connecting pieces is enhanced and the connecting pieces are prevented from breaking during repeated deformation processes. In addition, if the connecting pieces are exposed to the elastic structure 113, there is a height difference between each of the connecting pieces and a surface of the elastic structure 113, in which thousands of bacteria are easily harbored, which is not conducive to cleaning and poses certain hidden dangers to health of the user.

The elastic structure 113 is made from silicone, TPE, TPU, or PVC, which is not limited thereto. The brush rod 111 is made from hard plastic.

The present disclosure further provides a toothbrush 1.

As shown in FIGS. 1 and 2, the toothbrush 1 comprises the brush head 11 according to any one of the embodiments mentioned above.

In the toothbrush 1 of the embodiment of the present disclosure, the middle mounting portion 1194 is disposed between the two side mounting portions 1195, and the middle mounting portion 1194 is swingable with respect to the brush neck portion 1191, so that the bristle bundles 112 located in the middle area of the brush plate 1192 in the second direction X are movable, which reduces the probability of resonance between the bristle bundles 112 and the brush plate 1192. Further, in conjunction with the shock absorption function of the brush head body 119, for instance, the brush head body 119 is covered with the elastic structure 113, damages to the gums and enamel of the user are reduced, the user comfort is improved, the overall performance of the brush head 11 is improved, and competitiveness of the toothbrush 1 is improved.

A brush head body 119 of embodiments of the present disclosure is illustrated with reference to the drawings.

As shown in FIGS. 1-2 and 8-10, the brush head body 119 comprises a brush neck portion 1191 and fixing rings 114. The brush neck portion 1191 extends in a first direction L. The fixing rings 114 comprise bristle fixing holes 114A, each of the bristle fixing holes 114A runs through a corresponding fixing ring 114 in a third direction Y At least one of the bristle fixing holes 114A comprises a middle section and two end sections. The middle section and the end sections are disposed in the third direction Y The middle section is communicated with the end section 1144s. At least part of areas of cross sections of the end sections gradually decreases in a direction toward the middle section 1143. The first direction L is perpendicular to the third direction Y

Therefore, an assembly difficulty of the bristle bundles 112 is reduced. Processing quality of the head portions 1122 is high, which facilitates subsequent molding processes, improves mounting stability of the bristle bundles 112, and improves reliability of the brush head body 119.

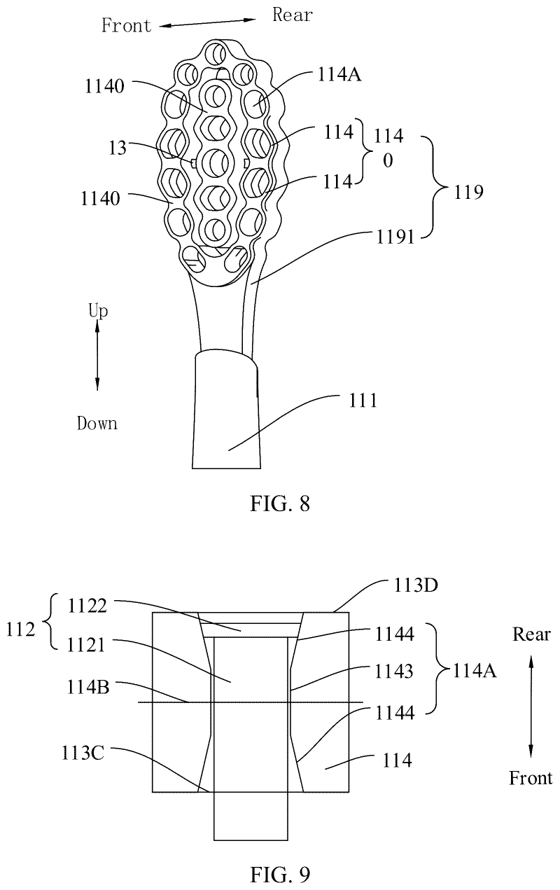

For instance, as shown in FIGS. 8-9, the brush head body 119 comprises the brush neck portion 1191 and the fixing rings 114. The brush neck portion 1191 extends along the first direction L. A first end of the brush neck portion 1191 is connected to the brush rod 111. The brush rod 111 is configured as a round rod, a square rod, or other structures that are easy for a user to hold. A second end of the brush neck portion 1191 is connected to the fixing rings 114. The brush plate 1192 extends linearly or obliquely in the first direction L. The fixing rings 114 are disposed in sequence and are perpendicular to the third direction Y to form a plate shape.

It should be noted that the first direction L is an up-down direction shown in FIG. 8, and the third direction Y is a front-rear direction shown in FIG. 8. The first direction L and the third direction Y are perpendicular to each other.

Each of the fixing rings 114 comprises the corresponding bristle fixing hole 114A. Each of the bristle fixing holes 114A penetrates the corresponding fixing ring 114 in the third direction Y, so that each of the bristle fixing hole 114A is the through hole and defines two ends. The two ends of each of the bristle fixing hole 114A are respectively a first end 114C and a second end 114D. The fixing end of each of the bristle bundles 112 extends from the first end 114C of a corresponding bristle fixing hole 114A into the corresponding bristle fixing hole 114A and extend to the second end 114D of the corresponding bristle fixing hole 114A. The fixing end of each of the bristle bundles 112 is melted to form the head portion 1122. There are many head portions 1122, and each of the head portions 1122 is configured to fix the corresponding bristle bundle 112 on the corresponding fixing ring 114. The bristle portion 1121 of each of the bristle bundles 112 passes through a corresponding middle section 1143 and extends out of the corresponding bristle fixing hole 114A from the first end 114C of the corresponding bristle fixing hole 114A.

In the third direction Y, at least one of the bristle fixing holes 114A comprises the middle section 1143 and two end sections 1144. The two end sections 1144 are respectively disposed on two ends of the middle section 1143. That is, the two end sections 1144 of the at least one of the bristle fixing holes 114A are respectively located at the first end 114C and the second end 114D of the at least one of the bristle fixing hole 114A, so that a first end sections 1144, the middle section 1143, and a second end section 1144 are sequentially disposed in the third direction Y The two end sections 1144 are communicated with the middle section 1143, and areas of cross sections of at least a portion of each of the end sections 1144 gradually decreases toward the middle section 1143.

It is understood that when the fixing end of at least one of the bristle bundles 112 corresponding to the at least one of the bristle fixing holes 114A extends from the first end 114C of the at least one of the bristle fixing holes 114A to the at least one of the bristle fixing holes 114A, the first end section 1144 located at the first end 114C guides the at least one of the bristle bundles 112, thereby reducing the difficulty of mounting the at least one of the bristle bundles 112. When the fixing end of the at least one of the bristle bundles 112 extends to the second end 114D of the at least one of the bristle fixing holes 114A, an overflow space is formed between the at least one of the bristle bundles 112 and an inner wall of the second end section 1144 located at the second end 114D, and molten liquid formed by melting the fixing end of the at least one of the bristle bundles 112 is allowed to flow into the overflow space to form a corresponding head portion 1122. A surface of the corresponding head portion 1122 is smooth, which is conducive to subsequent molding processes. Further, the middle section 1143 is further configured to limit the corresponding head portion 1122, which improves the mounting stability of the at least one of the bristle bundles 112.

In the embodiments of the brush head body 119 of the present disclosure, the two end sections 1144 are respectively disposed on the two ends of the middle section 1143, and the areas of the cross sections of at least a portion of each of the end sections 1144 gradually decreases toward the middle section 1143, thereby reducing the difficulty of mounting the at least one of the bristle bundles 112. Moreover, the overflow space is formed between the at least one of the bristle bundles 112 and the inner wall of the second end section 1144 located at the second end 114D, and the molten liquid formed by melting the fixing end of the at least one of the bristle bundles 112 is allowed to flow into the overflow space to form the corresponding head portion 1122. Processing quality of the head portions 1122 is high, which facilitates the subsequent molding processes, and improves the mounting stability of the bristle bundle 112 and the reliability of the brush head body 119.

In some embodiments of the brush head body 119 of the present disclosure, as shown in FIG. 9, the areas of the cross sections of the end sections 1144 gradually decreases in the direction toward the middle section 1143. By such arrangement, guiding effects of the end sections 1144 are improved, and an inclination of each of the end sections 1144 is reduced, the processing difficulty of the end sections 1144 is reduced, and the reliability of the brush head body 119 is improved.

In some embodiments of the brush head body 119 of the present disclosure, as shown in FIG. 9, in the third direction Y, areas of cross sections of the middle section 1143 are equal to each other. By such arrangement, a limiting effect of the middle section 1143 on the at least one of the bristle bundles 112 is improved, the mounting stability of the at least one of the bristle bundles 112 is improved, and the processing difficulty of the at least one of the bristle bundles 114A is reduced, which is conducive to reducing the processing cost.

In some embodiments of the brush head body 119 of the present disclosure, each of the areas of the cross sections of the middle section 1143 is equal to a minimum area of the cross sections of the end sections 1144. Thus, an area of a cross section of one end of each of the end sections 1144 close to the middle section 1143 is equal to an area of each of the cross sections of the middle section 1143, so that two side walls of the middle section 1143 are respectively smoothly connected to the inner walls of the end sections 1144, which improves mounting smoothness of the at least one of the bristle bundles 114A and reducing the processing difficulty of the brush head body 119.

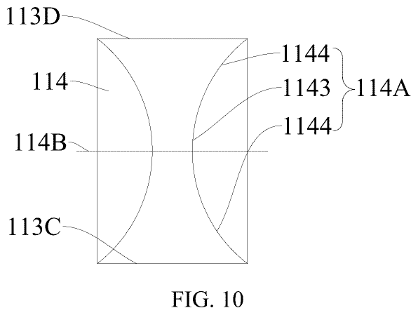

In some embodiments of the brush head body of the present disclosure, shapes of the cross sections of the two end sections 1144 are the same. For instance, as shown in FIGS. 9 and 10, shapes of the cross sections of the two end sections 1144 are circular, making the at least one of the bristle bundles 114A have a regular shape, so that at least one of the bristle bundles 114A is not easily twisted during mounting, and the free ends of the bristle bundles 112 are close to each other to improve the practicality of the brush head body 119. Of course, the shapes of the cross sections of the two end sections 1144 may also be configured as an ellipse, a hexagon, a triangle, a quadrilateral, an octagon, etc.

In some embodiments of the brush head body of the present disclosure, the shapes of the cross sections of the two end sections 1144 are different. For instance, the shapes of the cross sections of the first end section 1144 at the first end 114C of the at least one of the bristle fixing holes 114A are circular and the shapes of the cross sections of the second end section 1144 at the second end 114D of the at least one of the bristle fixing holes 114A is elliptical, so as to facilitate a distinction between the first end 114C and the second end 114D of the at least one of the bristle fixing holes 114A, which avoids reverse mounting of the at least one of the bristle bundles 112, and improves the reliability of the brush head body 119.

It should be noted that the cross sections of the end sections 1144 may be configured as a triangle, a rectangle, a circle, an ellipse, etc., which are not limited thereto.

In some embodiments of the brush head body 119 of the present disclosure, each of the bristle fixing holes 114A are symmetrically disposed with respect to a middle surface 15. The third direction Y is perpendicular to the middle surface 15. For instance, as shown in FIGS. 9 and 10, the third direction Y is perpendicular to the middle surface 15, each of the bristle fixing holes 114A are symmetrically disposed with respect to the middle surface 15, so the two end sections of at least one of the bristle fixing holes 114A are symmetrically disposed with respect to the middle surface 15. Therefore, the shapes of the bristle fixing holes 114A are regular, and the bristle bundles 112 are hardly twisted during the mounting process, which improves the reliability of the brush head body 119 and reduces the processing difficulty and cost of the brush head body 119.

In some embodiments of the brush head body of the present disclosure, each of the bristle fixing holes 114A comprises one middle section 1143 and two end sections 1144. For instance, as shown in FIG. 8, each of the bristle fixing holes 114A comprises one middle section 1143 and two end sections 1144, the two end sections 1144 thereof and are respectively disposed on two ends of the middle section 1143 thereof, and the two end sections 1144 thereof are connected to the middle section 1143 thereof. In this way, the mounting difficulty of each of the bristle bundles 112 is reduced, the processing quality of the head portions 1122 is improved, the processing difficulty and processing cost of the brush head body 119 are greatly reduced, and the processing quality of the brush head body 119 is improved.

In some embodiments of the brush head body 119 of the present disclosure, a depth of each of the bristle fixing holes 114A in the third direction Y is not less than 2 mm. Therefore, each middle section 1143 and corresponding end sections 1144 have sufficient size, which avoids the guiding and limiting functions of the corresponding end sections 1144 being affected by a size of each of the bristle fixing holes 114A, and avoids a tightening effect of each middle section 1143 on each of the bristle bundles 112 being affected by the size of each of the bristle fixing holes 114A, thereby improving the reliability of the brush head body 119.

Furthermore, depths of the bristle fixing holes 114A are equal, so that different bristle bundles 112 have similar states. Alternatively, depths of some of the bristle fixing holes 114A are greater than other bristle fixing holes 114A, so that some of the bristle bundles 112 have different states, which meets different design requirements and improves the practicality of the brush head body 119.

In some embodiments of the brush head body of the present disclosure, in a direction of longitudinal sections of each of the bristle fixing holes 114A parallel to the third direction Y, a peripheral wall of each of the bristle fixing holes 114A is as an arc line. For instance, as shown in FIG. 10, in the direction of the longitudinal sections of each of the bristle fixing holes 114A parallel to the third direction Y, the peripheral wall of each of the bristle fixing holes 114A is the arc line raised in a middle portion thereof, so that an inner wall of ach of the bristle fixing holes 114A has a gentle slope. When brushing the teeth, each of the bristle bundles 112 contacts the inner wall of a corresponding bristle fixing hole 114A smoothly, shearing force thereof is small, so that the bristle bundles 112 are not prone to permanent deformation and maintain resilience for a long time, which increases service life of the bristle bundles 112.

Of course, in the direction of longitudinal sections of each of the bristle fixing holes 114A parallel to the third direction Y, the peripheral wall of each of the bristle fixing holes 114A may also be a straight line to improve guiding effects of the end sections 1144 of each of the bristle fixing holes 114A on the corresponding bristle bundle 112, so that each of the bristle bundles 112 are allowed to be inserted into the corresponding bristle fixing hole 114A.

In some embodiments of the brush head body 119 of the present disclosure, at least part of an outer peripheral wall of each of the fixing rings 114 is an inclined surface and/or a curved surface.

For instance, as shown in FIG. 2, a portion of the outer peripheral wall of the each of the fixing rings 114 forms the inclined surface, or all the outer peripheral wall of each of the fixing rings 114 forms the inclined surface. Alternatively, a portion of the outer peripheral wall of each of the fixing rings 114 forms the curved surface, or all the outer peripheral wall of each of the fixing rings 114 forms the curved surface. In this way, an area of the outer peripheral wall of each of the fixing rings 114 is made larger. When the elastic structure 113 is covered on the outer side of the fixing rings 114, the contact area between the elastic structure 113 and the fixing rings 114 is larger, connecting force thereof is large, so that the elastic structure 113 is not easy to be peeled off. As a result, the reliability of the brush head body 119 is improved.

Furthermore, in the third direction Y, areas of cross sectionals of the outer peripheral wall of each of the fixing rings 114 gradually increase. For instance, in the third direction Y, the areas of the cross sections of the peripheral wall of each of the fixing rings 114 gradually increases in a direction from the first end 114C to the second end 114D of each of the bristle fixing holes 114A, so that the elastic structure 113 covered on the outer side of the fixing rings 114 forms an inverted structure, thereby improving the mounting stability of the elastic structure 113. In particular, when the bristle bundles 112 are subjected to lateral force, resulting in inconsistent deformation of the elastic structure 113 and the fixing rings 114, the elastic structure 113 is prevented from peeling off from the fixing rings 114. Thus, the reliability of the brush head body 119 is improved.

In some embodiments of the brush head body 119 of the present disclosure, at least part of the fixing rings 114 are sequentially disposed in the first direction L. For instance, as shown in FIG. 8, at least part of the fixing rings 114 are sequentially disposed in the first direction L, and the corresponding bristle bundle 112 is mounted in the bristle fixing hole 114A of each of the fixing rings 114, so that the bristle bundles 112 are sequentially disposed in the first direction L, and the bristle bundles 112 are configured to clean the oral cavity, thereby improving the cleaning efficiency of the bristle bundles 112 on the oral cavity. Therefore, the practicality of the brush head body 119 is improved.

Furthermore, outer peripheral walls of any two adjacent fixing rings 114 sequentially disposed in the first direction L are directly connected. Therefore, the fixing rings 114 are closely connected to each other, and more bristle fixing holes 114A are defined on per unit area of the brush head body 119, so that more bristle bundles 112 are mounted, thereby improving the cleaning efficiency of the bristle bundles 112 on the oral cavity and improving the practicality of the brush head body 119.

In some embodiments of the brush head body 119 of the present disclosure, at least part of the fixing rings 114 are sequentially disposed in a second direction X. The second direction X is perpendicular to the first direction L and the third direction Y It should be noted that the second direction X is a left-right direction shown in FIG. 2, and the first direction L, the third direction Y and the second direction X are perpendicular to each other.

For instance, as shown in FIGS. 2-8, at least part of the fixing rings 114 are sequentially disposed in the first direction L, the corresponding bristle bundle 112 is mounted in the bristle fixing hole 114A of each of the fixing rings 114, at least part of the fixing rings 114 are sequentially disposed in the second direction X, and the bristle bundles 112 are configured to clean the oral cavity, thereby improving the cleaning efficiency of the bristle bundles 112 on the oral cavity. Therefore, the practicality of the brush head body 119 is improved.

In some embodiments of the brush head body 119 of the present disclosure, in the second direction X, the brush neck portion 1191 comprises rows of fixing ring groups 1140 disposed in sequence, and each of the rows of fixing ring groups comprises the fixing rings 114 sequentially disposed in the first direction L.

For example, as shown in FIG. 8, the brush neck portion 1191 comprises the rows of fixing ring groups 1140. The rows of fixing ring groups 1140 are spaced apart in the second direction X and are connected to the end portion of the brush neck portion 1191. Each of the rows of fixing ring groups 1140 comprises the fixing rings 114. The fixing rings 114 in the same fixing ring group 1140 are sequentially disposed in the first direction L. Each of the bristle bundles 112 is mounted in the bristle fixing hole 114A of each of the fixing rings 114, so that the bristle bundles 112 are sequentially disposed in the second direction X and the first direction L. The bristle bundles 112 are used together to clean the oral cavity to improve the cleaning efficiency of the bristle bundles 112 on the oral cavity. Thus, the practicality of the brush head body 119 is improved.

In some embodiments of the brush head body 119 of the present disclosure, at least one row of the fixing ring groups is capable of swinging with respect to the brush neck portion 1191.

For instance, one of the rows of fixing ring groups 1140 is connected to the brush neck portion 1191 through a movable connecting plate, so that the one of the rows of fixing ring groups 1140 is swingable with respect to the brush neck portion 1191. Alternatively, some of the rows of fixing ring groups 1140 are connected to the brush neck portion 1191 through the movable connecting plate, so that some of the rows of fixing ring groups 1140 are swingable with respect to the brush neck portion 1191. Alternatively, as shown in FIG. 8, one of the rows of fixing ring groups 1140 is connected to another row of fixing ring groups 1140 through movable connecting plate, so that the one of the rows of fixing ring groups 1140 is swingable with respect to the brush neck portion 1191, which is not limited thereto.

It is understood that by setting the at least one of the rows of fixing ring groups 1140 to be swingable with respect to the brush neck portion 1191, the at least one of the rows of fixing ring groups 1140 has a larger swing range so that corresponding bristle bundles 112 have a larger swing range, and the corresponding bristle bundles 112 are able to clean junctions between the gums and the teeth and innermost ends of the teeth, thereby improving the cleaning effect of the corresponding bristle bundles 112 and improving the reliability of the brush head body 119.

It should be noted that a width of the movable connecting plate 117 is 0.8-1.2 mm, and is preferably 1 mm. In this way, the movable connecting plate has a suitable swing range, and a structural strength of the movable connecting plate can be prevented from being too weak, thereby improving the reliability of the brush head body 119.

In some embodiments of the brush head body 119 of the present disclosure, in the second direction X, a gap is provided between each two adjacent fixing ring groups 1140.

For instance, as shown in FIG. 8, in the second direction X, the fixing ring groups 1140 are spaced apart and are connected to the brush neck portion 1191, so that a gap is formed between each two adjacent fixing ring groups 1140. In this way, each two adjacent fixing ring groups 1140 are allowed to have different freedom degrees, which meets different design requirements, and enables the elastic structure 113 being filled between outer walls of each two fixing ring groups 1140, thereby improving the mounting stability of the elastic structure 113. As a result, the practicality of the brush head body 119 is improved.

Furthermore, as shown in FIG. 8, the fixing rings 114 of any one of the fixing ring groups 1140 and the fixing rings 114 of an adjacent fixing ring group are staggered, so that the gap between each two adjacent fixing ring groups 1140 is in a wave shape, which improves the mounting stability of the elastic structure 113. Moreover, a limited area thereof is fully used to enable more fixing rings 114 being defined in per unit area, so that more bristle bundles 112 are allowed to be mounted. Thus, the practicality of the brush head body 119 is improved.

In some embodiments of the brush head body 119 of the present disclosure, shapes of cross sections of any two adjacent bristle fixing holes 114A are different.

For instance, shapes of cross sections of any one of the bristle fixing holes 114A are circular, so that shapes of cross sections of a corresponding bristle bundle 112 are circular, and the shapes of cross sections of an adjacent bristle fixing hole 114A are elliptical, so that shapes of cross sections of the corresponding bristle bundle 112 are elliptical. In this way, a diversified arrangement of the bristle bundles 112 is realized, Further, the bristle bundles 112 of different shapes cause bristles at different positions to generate different forces when the bristle bundles contact the teeth (for example, directions and magnitudes of the forces are different), and a contact area between the bristle bundles and the teeth increases. Thus, practicality of the brush head body 119 is improved.

In some embodiments of the brush head body 119 of the present disclosure, areas of cross sections of any two adjacent bristle fixing holes 114A are different.

For instance, areas of the cross sections of anyone of the bristle fixing holes 114A is configured to be small, so that areas of the cross sections of the corresponding bristle bundle 112 is small accordingly. At the same time, areas of the cross sections of another bristle fixing hole 114A is configured to be large, so that the areas of the cross sections of the corresponding bristle bundle 112 is large accordingly. In this way, a diversified arrangement of the bristle bundles 112 is realized, and the shape of the bristle bundles 112 are enabled to well fit the teeth of the user, thereby improving the comfort of the user and improving the practicality of the brush head body 119.

The present disclosure provides a brush head 11.

As shown in FIGS. 1 and 2, the brush head 11 of the embodiments of the present disclosure comprises the brush head body 119 according to any one of the embodiments mentioned above and an elastic structure 113 wrapped around outer peripheral walls of the fixing rings 114, and bristle bundles 112. The bristle bundles 112 are respectively fixed in the bristle fixing holes 114A of the fixing rings 114. The bristle bundles 112 comprises bristle portions 1121 and head portions 1122. Each of the head portions 1122 is filled in a corresponding first end section 1144 and is connected to an inner wall surface of the corresponding first end section 1144. Each of the bristle portions 1121 is connected to a corresponding head portion 1122, passes through a corresponding middle section 1143, and stretches out from a corresponding second end section 1144. The elastic structure 113 is made from elastic material such as rubber. The elastic structure 113 is configured to separate the brush head body 119 from the oral cavity to prevent the brush head 11 from being too hard to cause discomfort.

In the brush head 11 of the embodiment of the present disclosure, the two end sections 1144 are respectively disposed on two ends of the middle section 1143, and the areas of the cross sections of at least part of the end sections 1144 of each of the bristle fixing holes 114A gradually decreases toward the middle section 1143 of each of the bristle fixing holes 114A, which reduce an assembly difficulty of the bristle bundles 112, and enables an overflow space being formed between a fixing end of each of the bristle bundles 112 and the inner wall of the corresponding end section 1144. A melting liquid formed by melting each of the bristle bundles 112 is allowed to flow into a corresponding overflow space to form a corresponding head portion 1122. Processing quality of the bristle portions 1121 is high, which facilitates subsequent molding processes, improves the mounting stability of the bristle bundles 112, improves the reliability of the brush head body, and improves the overall performance of the brush head.

The present disclosure further provides a toothbrush 1.

As shown in FIGS. 1 and 2, the toothbrush comprises the brush head according to any one of the embodiments mentioned above.

In the tooth brush 11 of the embodiment of the present disclosure, the two end sections 1144 are respectively disposed on two ends of the middle section 1143, and the areas of the cross sections of at least part of the end sections 1144 of each of the bristle fixing holes 114A gradually decreases toward the middle section 1143 of each of the bristle fixing holes 114A, which reduce an assembly difficulty of the bristle bundles 112, and enables an overflow space being formed between a fixing end of each of the bristle bundles 112 and the inner wall of the corresponding end section 1144. A melting liquid formed by melting each of the bristle bundles 112 is allowed to flow into a corresponding overflow space to form a corresponding head portion 1122. Processing quality of the bristle portions 1121 is high, which facilitates subsequent molding processes, improves the mounting stability of the bristle bundles 112, improves the reliability of the brush head body, improves the overall performance of the brush head, and improves the competitiveness of toothbrush 1.

It should be noted that the toothbrush 1 in the embodiments of the present disclosure may be an ordinary toothbrush or an electric toothbrush, which is not limited thereto.

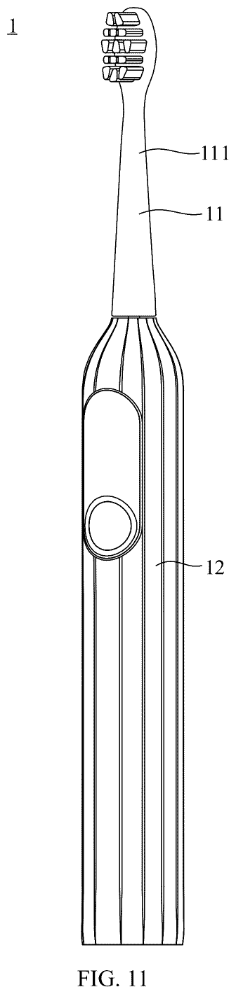

As shown in FIG. 11, the embodiments of the present disclosure provide an electric toothbrush 1. The electric toothbrush 1 comprises the brush head 11 and a brush handle 12. The brush head 11 is configured to place into the mouth of the user to clean the oral cavity. The brush handle 12 is configured for the user to hold and use the electric toothbrush 1.

Specifically, the brush handle 12 is connected to the brush head 11 and is configured to drive the brush head 11 to move. When the user holds the brush handle 12 and places the brush head 11 into a part to be cleaned in the oral cavity, the brush head 11 brushes the oral cavity. The brush handle 12 comprises a housing, a bracket, a motor, a battery, etc. The motor and the battery are mounted on the bracket to form a core. The housing defines an accommodating cavity, and the core is mounted in the accommodating cavity. The housing protects the motor and the battery, so a probability of damage to the motor and the battery is reduced, enabling the motor and the battery to have a longer service life, thus enabling the electric toothbrush 1 to have a longer service life. An output shaft of the motor is connected to the brush rod 111 to drive the brush head 11 to move, thereby driving the bristle bundles to move, so as to clean the oral cavity of the user.

As shown in FIGS. 11-15, in one specific embodiment, the brush head 11 comprises a brush rod 111, a brush head body 119, an elastic structure 113, fixing rings 114, and bristle bundles 112.

One end of the brush rod 111 is configured to connect with the brush handle 12 and defines a first direction L.

The brush head body 119 is connected to the one end of the brush rod 111 in the first direction L and the brush head body 119 comprises the fixing rings 114. The fixing rings 114 one-to-one comprise bristle fixing holes 114A. Each of the bristle fixing holes 114A penetrates a corresponding fixing rings 114 in a third direction Y of the brush head body 119. The fixing rings 114 are at least partially embedded in the elastic structure 113. Rubber filling gaps are defined between at least parts of the adjacent fixing rings 114, so that the adjacent fixing rings 114 are allowed to move with respect to each other through each of the rubber filling gaps. The third direction Y is perpendicular to the first direction L.

For instance, the fixing rings 114 may be made from hard rubber or hard plastic; so that the fixing rings 114 are able to support the bristle bundles 112.

The elastic structure 113 covers an outer side of the brush head body 119 and filled in each of the rubber filling gaps. The elastic structure 113 comprises a bristle fixing surface and a back surface. The bristle fixing surface and the back surface of the elastic structure 113 are disposed opposite to each other in the third direction Y. The elastic structure 113 is made from silicone, thermoplastic elastomer (TPE), thermoplastic polyurethanes (TPU), or polyvinyl chloride (PVC), which is not limited thereto. The brush rod 111 is made from hard plastic.

The bristle bundles 112 respectively pass through the bristle fixing holes 114A. The bristle bundles 112 comprise bristle portions 1121 and head portions 1122. Each of the bristle portions 1121 is connected to one end of a corresponding bristle portion. Each of the head portions 1122 is formed by melting an end portion of the corresponding bristle portion 1121. Each of the bristle portions 1121 extends out of one side, facing towards the bristle fixing surface of the elastic structure, of a corresponding bristle fixing hole 114A. Each of the head portions 1122 is disposed on one side, away from the bristle fixing surface of the elastic structure 113, of a corresponding fixing ring 114. It is understandable that, during the production process, one end of each of the bristle bundles 112 is first passed through the corresponding bristle fixing hole 114A, and the one end of each of the bristle bundles 112 passing through the corresponding bristle fixing hole 114A is melted to form a corresponding head portion 1122. Specifically, the bristle bundles 112 are made from nylon.

The elastic structure 113 wraps the outer side of the brush head body 119 and filled in each of the rubber filling gaps defined between at least part of adjacent fixing rings 114. The elastic structure 113 has a strong deformation ability, so that the fixing rings 114 have a strong mobility, and when the bristle bundles 112 vibrate, the bristle bundles 112 have a larger vibration amplitude, so as to improve the cleaning ability of the bristle bundles 112 on dead corners of the oral cavity. The elastic structure 113 wrapping layers the brush head 11, which buffers vibration transmission from the back surface 113A2 of the elastic structure to the inner wall of the oral cavity of the user, so as to improve a brushing experience of the user.

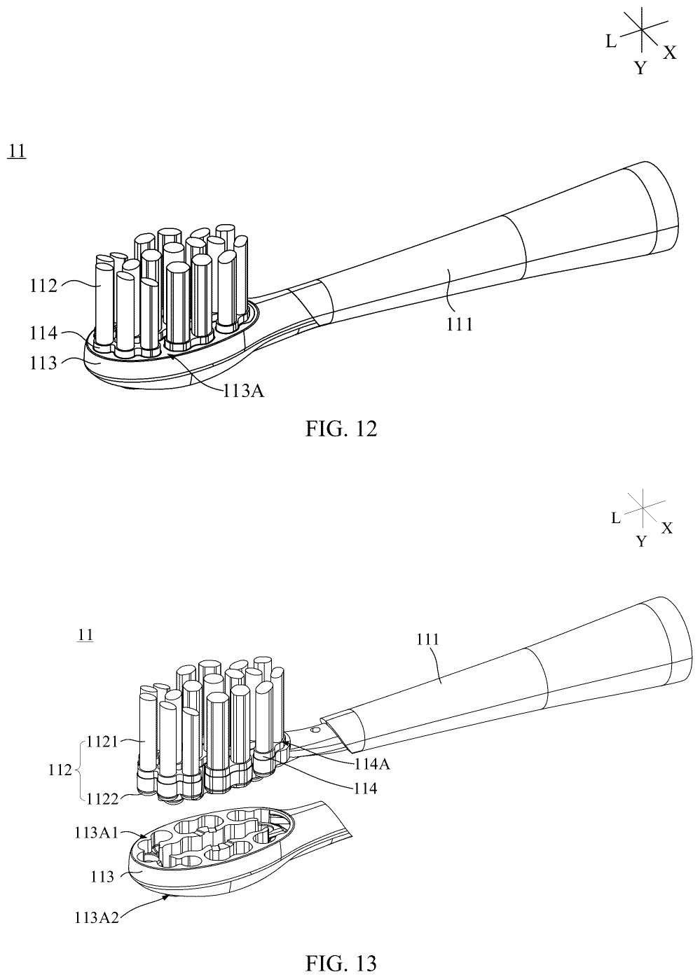

As shown in FIGS. 12-14, an outer edge of each of the head portions 1122 exceeds an inner edge of the corresponding fixing ring 114, which prevents the bristle bundles from separating from the fixing rings 114 and improves connection stability between the bristle bundles and the fixing rings 114. Further, by such arrangement, a contact area between the head portions 1122 and the fixing rings 114 is large, thereby improving the connection stability between the bristle bundles 112 and the fixing rings 114.

Furthermore, the outer edge of each of the head portions 1122 does not exceed an outer edge of a corresponding bristle fixing hole 114A or a length of the outer edge of each of the head portions 1122 exceeding the outer edge of the corresponding bristle fixing hole 114A is not greater than 0.3 mm, which prevents the head portions 1122 from exceeding the fixing rings 114 too much, so as to reduce the influence of mutual movement of the head portions 1122 of any two adjacent bristle bundles 112 when the fixing rings 114 move, thereby allowing the fixing rings 114 to have a large moving range and improving the mobility of the bristle bundles 112, so that the bristle bundles have a strong cleaning effect.

If the outer edge of each of the head portions 1122 is within the inner edge of the corresponding fixing ring 114, each of the head portions 1122 is easily separated from the corresponding bristle fixing hole 114A, causing the bristle bundles 112 to easily separate from the fixing rings 114. If the length of the outer edge of each of the head portions 1122 exceeding the outer edge of the corresponding bristle fixing hole 114A is greater than 0.3 mm, each of the head portions 1122 exceeds the corresponding fixing ring 114 too much, causing each two adjacent head portions 1122 to easily affect each other when the fixing rings 114 move. A reason thereof is that a distance between each two adjacent head portions 1122 is smaller and a portion of the elastic structure between each two adjacent head portions 1122 is less, which affects the moving range of the fixing rings 114, resulting in a smaller movement range of the bristle bundles 112 and a poor cleaning effect of the bristle bundles on the oral cavity of the user.

As shown in FIGS. 12-14, in one specific embodiment, an outer contour line of each of the head portions 1122 is located between a contour line of a hole opening of the corresponding bristle fixing hole 114A and an outer contour line of the corresponding fixing ring 114, which reduces the probability of the head portions 1122 being separated from the bristle fixing holes 114A, thereby reducing the probability of the bristle bundles 112 being separated from the fixing rings 114. Further, the contact area between the head portions 1122 and the fixing rings 114 is large, which improves the connection stability between the bristle bundles 112 and the fixing rings 114. Further, because the head portions 1122 are prevented from exceeding too much of the fixing rings 114, the influence of mutual movement of the head portions 1122 of any two adjacent bristle bundles 112 is reduced when the fixing rings 114 move, thereby allowing the fixing rings 114 to have the large moving range, so that the bristle bundles have the strong cleaning effect on the oral cavity of the user.

As shown in FIGS. 12-14, in one specific embodiment, each two adjacent head portions 1122 are spaced apart, so the fixing rings 114 have the large moving range and the bristle bundles 122 have a strong cleaning effect on the oral cavity of the user.

As shown in FIGS. 12-15, in one specific embodiment, a first distance L1 is defined between two fixing rings 114 adjacent to each of the rubber filling gaps. The first distance L1 is not less than 1.3 mm, so that there is a larger gap between each two adjacent fixing rings 114, which facilitates the movements between each two adjacent fixing rings 114. Moreover, each two adjacent fixing rings 114 have a large movement amplitude, so that the bristle bundles 112 have a large swing range, thereby improving the cleaning ability of the bristle bundles 112 to the oral cavity of the user. If the first distance L1 is less than 1.3 mm, each two adjacent fixing rings 114 may easily affect each other when each two adjacent fixing rings 114 move, which reduces the movement range of the fixing rings 114, affects the swing range of the bristle bundles 112, and reduces the cleaning ability of the bristle bundles to oral cavity of the user. Specifically, the first distance L1 may be 1.3 mm, 1.4 mm, 1.5 mm, 1.6 mm, etc.

As shown in FIGS. 12-15, in one specific embodiment, a second distance 12 is defined between the two fixing rings 114 adjacent to each of the rubber filling gaps in the first direction L. A third distance L3 is defined between the two fixing rings 114 adjacent to each of the rubber filling gaps in the second direction X. The second direction X is perpendicular to the first direction L and the third direction Y. Since when the user uses the brush head 11 to clean the teeth in the mouth, the bristle bundles move in the second direction X and the third distance L3 is greater than the second distance L2, the movement amplitude of the fixing rings 114 in the second direction X is greater than the movement amplitude of the fixing rings 114 in the first direction L. Therefore, the movement amplitude of the bristle bundles 112 in the second direction X is larger, which is more in line with a movement mode of the bristles of the bristle bundles when the user brushes the teeth, thereby improving the cleaning ability of the bristles on the oral cavity of the user.

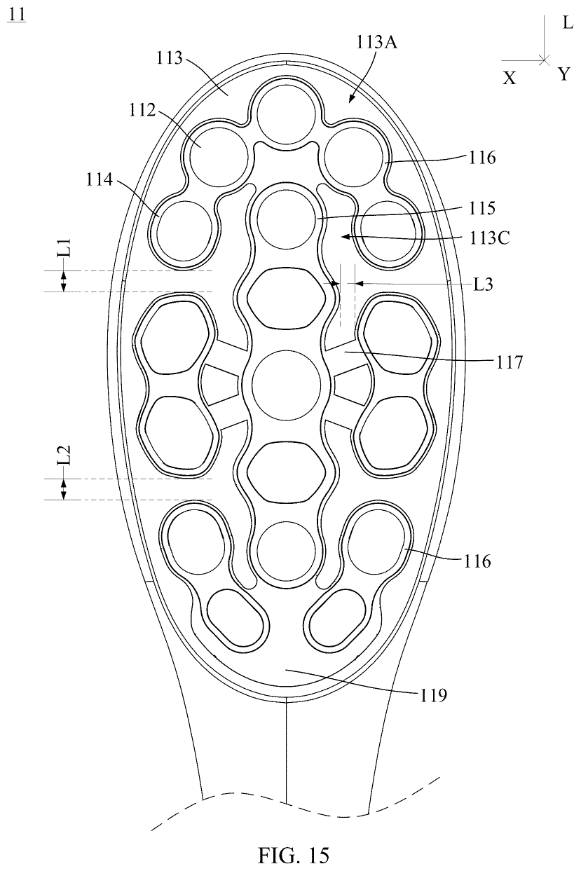

As shown in FIGS. 12 and 15, in one specific embodiment, each of the rubber filling gaps is defined between each of the fixing rings 114 and at least one adjacent fixing ring 114.

It is understood that in one specific embodiment, each of the fixing rings 114 is spaced apart from the adjacent fixing ring 114 so that each of the fixing rings 114 has a large movement range and each of the bristle bundles 112 has a large movement range, thereby improving the cleaning ability of the bristle bundles 112 on the oral cavity of the user.

In another specific embodiment, each of the fixing rings 114 is connected to at least one fixing ring, and each of the rubber filling gaps is defined between each two adjacent fixing rings 114. Each of the rubber filling gaps makes corresponding two fixing rings 114 have a large movement range, thereby making the corresponding bristle bundles have a large movement range. The fixing rings 114 connected to each other make the corresponding bristle bundles have stronger elasticity, so that the bristle bundles have a stronger cleaning ability for the oral cavity of the user.

It is understood that in another specific embodiment, the fixing rings 114 comprise at least one isolation fixing ring isolated from other fixing rings, and rubber filling gaps are defined between the isolation fixing ring and the fixing rings 114 adjacent to the isolation fixing ring. Since the isolation fixing ring is isolated from the other fixing rings 114, the isolation fixing ring ha a large movement range, so that a bristle bundle corresponding to the isolation fixing ring has a large movement range, so that the movable bristle bundles are able to extend into corners of the teeth, so as to clean the corners of the teeth and improve the cleaning effect.

As shown in FIGS. 12 and 15, in one specific embodiment, the fixing rings 114 form the fixing ring groups. Each of the fixing ring groups comprises at least two fixing rings 114. The fixing ring groups improve the cleaning ability of the bristle bundles 112 on the same area. In each of the fixing ring groups, the brush head 11 further comprises connecting portions. Each of the connecting portions is disposed between each two adjacent fixing rings 114 in the same fixing ring group, so no rubber filling gap is formed therein, so the connection between the fixing rings 114 in the same fixing ring group is made tighter. The bristle bundles 112 corresponding to the same fixing ring group have similar swing directions and swing ranges, so as to clean a same tooth area together, which improve the cleaning effect of the same tooth area. Each of the rubber filling gaps is formed between each two adjacent fixing ring groups. In this way, through each of the rubber filling gaps, the bristle bundles 112 in different fixing ring groups have different swing ranges and/or swing angles. Since both of the oral cavity and the teeth define irregular surfaces, the bristle bundles with different swing ranges and/or swing angles are able to fully contact irregular surfaces of the oral cavity and the teeth, thereby improving the cleaning ability of the bristle bundles.

As shown in FIGS. 12-16, in one specific embodiment, the fixing rings 114 one-to-one comprise protrusions 1141 protruding from the bristle fixing surface of the elastic structure, so that a guide channel 113B is formed between the fixing ring groups. The guide channel 113B facilitates flowing of liquid along the guide channel 113B, facilitates the liquid to leave the brush head 11, reduces a probability of liquid remaining on the bristle fixing surface 113A1 of the elastic structure 113, thereby reducing a probability of growth of bacteria on the bristle fixing surface 113A1 of the elastic structure 113, thereby providing reliable protection for the health of the user.

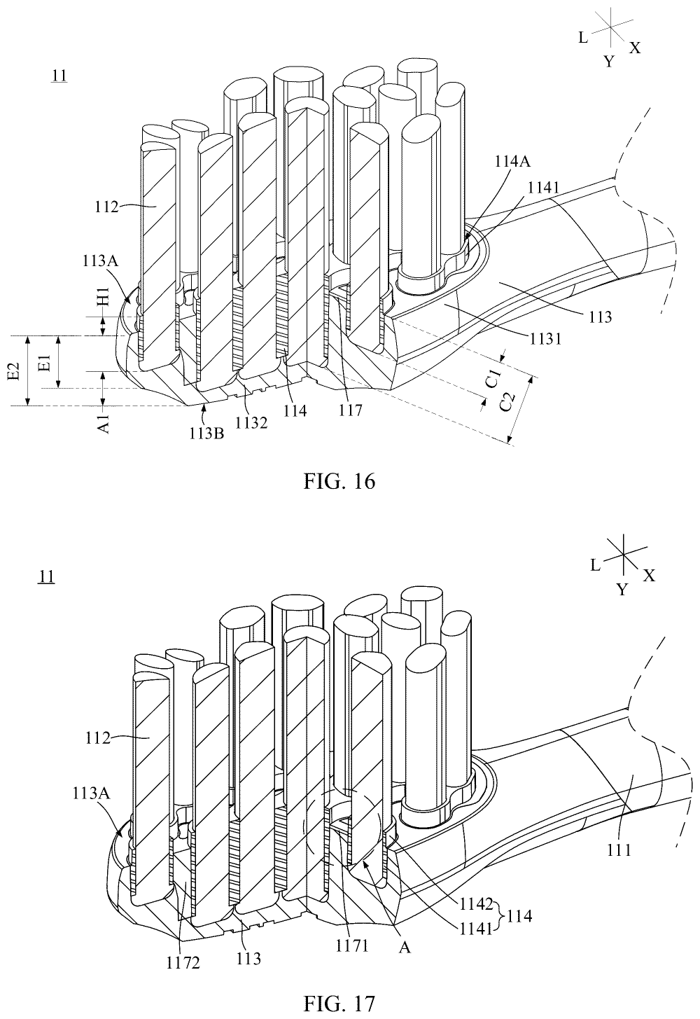

As shown in FIGS. 12 and 16, in one specific embodiment, when lengths of the fixing rings 114 are fixed, each of the protrusions 1141 has a first height H1 with respect to the bristle fixing surface 113A1 of the elastic structure 113, and the first height H1 is not less than 0.6 mm and not greater than 2 mm. In this way, the length of each of the bristle bundles 112 extending from the corresponding fixing ring 114 is large, so that each of the bristle bundles 112 has a great deformation ability, thereby improving the cleaning ability of the bristle bundles 112's on the oral cavity of the user. If the first height H1 is less than 0.6 mm, the protrusions 1141 hardly support the bristle bundles 112, resulting in poor elasticity of the bristle bundles 112 and poor cleaning effect of the bristle bundles 112 on the oral cavity of the user. If the first height H1 is greater than 2 mm, the height of each of the protrusions 1141 protrudes from the bristle fixing surface 113A1 of the elastic structure too much, resulting in poor elasticity of the bristle bundles 112, poor deformation ability of the bristle bundles 112, and poor cleaning effect of the bristle bundles 112, on the oral cavity of the user. Specifically, the first height H1 is 0.6 mm, 0.7 mm, 1 mm, 1.2 mm, 1.5 mm 2 mm, etc.

As shown in FIGS. 12, 15, and 16, in one specific embodiment, the brush head further comprises connecting pieces 117. Each of the connecting pieces 117 is connected to two fixing rings 114 adjacent to each other and spaced apart from each other, so that all of the fixing rings 114 are connected into a whole. Therefore, it is easy to place all of the fixing rings 114 together in a mold to form the elastic structure 113, and the number of clamps configured to clamp the fixing rings 114 is reduced, as a result, the number of clamping times and the number of working steps are reduced, which improves the production efficiency of the brush head 11. Furthermore, since all of the fixing rings 114 are connected as a whole, it is easy to position the fixing rings 114, and a mounting accuracy of the fixing rings 114 is improved, thereby improving the production quality of the brush head 11.

The connecting pieces 117 are embedded into the elastic structure 113 and is flush with the bristle fixing surface 1131 of the elastic structure 113, enabling the bristle fixing surface 113A1 of the elastic structure 113 being a flat surface to prevent liquid from remaining on the bristle fixing surface 113A1 of the elastic structure 113, and prevent dirt from accumulating in dead corners thereof, and thus preventing the bacteria from growing on the bristle fixing surface 113A1 of the elastic structure 113 and providing reliable protection for the health of the user.

Specifically, the connecting pieces 117 are elastic connecting pieces 117, so that the fixing rings 114 connected by the connecting pieces 117 are able to deform and displace, and the fixing rings 114 adjacent to each other and spaced apart from each other are connected as a whole.

As shown in FIGS. 12 and 16, in one specific embodiment, top ends of the protrusions 1141 are flush, so that the fixing rings 114 have similar ability to fix the head portions of the bristle bundles 112. Therefore, by determining lengths of sections (e.g., exposed sections) of the bristle bundles 112 extending out of the fixing ring 114, the deformation amplitudes of the bristle bundles 112 are easily determined. For instance, the lengths of the exposed sections of some of the bristle bundles 112 are designed to be same, so that the deformation amplitudes of some of the bristle bundles 112 are made consistent to a certain extent, and the swing ranges of some of the bristle bundles 112 are made consistent. Therefore, the bristle bundles 112 bring similar touch sensations to the oral cavity when brushing the teeth, and at the same time, the sizes of the cleaning areas of some of the bristle bundles 112 are similar, which is conducive to uniform cleaning of the oral cavity of the user.

As shown in FIGS. 12 and 16, in one specific embodiment, each of the head portions 1122 is smoothly connected to the corresponding bristle portion 1121. Therefore, stress between each of the head portions 1122 and the corresponding bristle portion 1121 is reduced. As a result, during the movement of the fixing rings 114, a probability of the head portions 1122 and the bristle portions 1121 being broken is reduced, and a probability of the bristle bundles 112 being separated from the fixing rings 114 is reduced, so that the bristle bundles 112 have a longer service life and the brush head 11 has a longer service life.

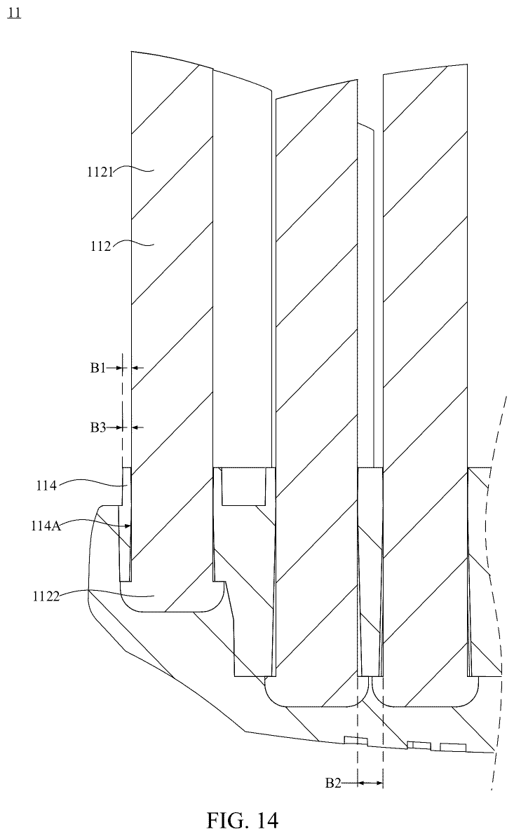

As shown in FIGS. 12 and 14, in one specific embodiment, when apertures K of the bristle fixing holes 114A of the fixing rings are fixed, each of the fixing rings 114 has a first wall thickness B1. The first wall thickness B1 is not less than 0.18 mm, making the fixing rings 114 thick and have a strong structural strength. When the bristle bundles 112 swing, the fixing rings 114 are not easy to deform, so that the probability of the bristle bundles separating from the fixing rings 114 is low. In addition, due to the strong structural strength of the fixing rings 114, the fixing rings 114 has a strong support capacity for the bristle bundles, so that the elasticity of the bristle bundles is strong and the bristle bundles have a strong cleaning ability for the oral cavity of the user, thereby improving the cleaning effect of the brush head 11 on the oral cavity of the user.

When the apertures K of the bristle fixing holes 114A of the fixing rings 114 are constant, if the first wall thickness B1 is less than 0.18 mm, the fixing rings 114 are thin, resulting in poor structural strength of the fixing rings 114. Therefore, when the bristle bundles swing, the fixing rings 114 are easy to deform, causing the bristle bundles to easily separate from the fixing rings 114. In addition, since the fixing rings 114 are easy to deform, the support capacity for the bristle bundles is poor, resulting in poor elasticity of the bristle bundles and resulting in poor cleaning ability of the bristle bundles for the oral cavity of the user. For instance, the first wall thickness B1 is 0.18 mm, 0.2 mm, 0.3 mm, 0.4 mm, 0.5 mm, etc.

As shown in FIGS. 12 and 14, in one specific embodiment, each of the fixing rings 114 has a first wall thickness B1 and the first wall thickness B1 is not less than 0.2 mm and not greater than 0.4 mm. For instance, the first wall thickness B1 is 0.2 mm, 0.3 mm, or 0.4 mm.

As shown in FIGS. 12, 14 and 15, in one specific embodiment, the fixing rings 114 comprise middle fixing rings 115 and side fixing rings 116. The middle fixing rings 115 are sequentially connected in the first direction L. The side fixing rings 116 surround a peripheral side of the middle fixing rings 115. Each of the middle fixing rings 114 has a second wall thickness B2, each of the side fixing rings 114 has a third wall thickness B3. The second wall thickness B2 is greater than the third wall thickness B3, so that a structural strength of each of the middle fixing rings 115 is greater than a structural strength of each of the side fixing rings 116, enabling the middle fixing rings 115 being used as a portion of a skeleton of the brush head 11 to support the bristle bundles. Therefore, the bristle bundles have greater elastic deformation ability, thereby improving the cleaning ability of the bristle bundles on the oral cavity of the user.

As shown in FIGS. 12 and 15, in one specific embodiment, an outer contour line formed by the middle fixing rings 115 is a wavy line to guide the liquid, which reduces the probability of liquid remaining on the bristle fixing surface 113A1 of the elastic structure, reduces the probability of the bacteria growing on the bristle fixing surface 113A1 of the elastic structure, and provides reliable protection for the health of the user. Furthermore, the side fixing rings 116 are spaced apart from the middle fixing rings 115. At least part of the side fixing rings 116 is disposed opposite to wave troughs of the wavy line to further guide the liquid, which further reduces the probability of liquid remaining on the bristle fixing surface 113A1 of the elastic structure, further reduces the probability of the bacteria growing on the bristle fixing surface 113A1 of the elastic structure, and provides reliable protection for the health of the user.

As shown in FIGS. 12, 15 and 16, in one specific embodiment, a first distance A1 is formed between one side of each of the side fixing rings 116 facing a corresponding head portion 1122 and the back surface 113A2 of the elastic structure 113. The first distance is not less than 2 mm and not greater than 5 mm.

The distance between the side fixing rings 116 and the back surface 113A2 of the elastic structure is large, so that the elastic structure 113 is allowed to wrap the head portions 1122 after injection molding, thereby increasing the contact area between the elastic structure 113 and the bristle bundles, improving the connection stability between the bristle bundles and the elastic structure 113, and reducing the probability of the bristle bundles or being separated from the elastic structure 113.

If the first distance A1 is less than 2 mm, the elastic structure 113 is too thin, so that the elastic structure 113 is not sufficient to completely wrap the head portions 1122, which causes the head portions 1122 to be exposed outside, causing the head portions 1122 to be easily worn until they fall off, causing the bristle bundles to fall off, and affecting the use of the bristle bundles to clean the oral cavity by the user.

If the first distance A1 is greater than 5 mm, the elastic structure 113 is too thick, resulting in a thicker brush head 11. When the user uses the thicker brush head 11 to clean the oral cavity, the thicker brush head 11 enters the oral cavity, bringing a strong foreign body sensation to the oral cavity of the use, which is easy to cause discomfort to the user, thereby reducing the user experience. For instance, the first distance A1 is 2 mm, 3 mm, 4 mm, or 5 mm.

As shown in FIGS. 12 and 16, in one specific embodiment, a depth of the middle fixing rings 115 embedded in the elastic structure 113 from the bristle fixing surface 113A1 is defined as a first depth C1. A depth of the side fixing rings 114 embedded in the elastic structure 113 from the bristle fixing surface is defined as a second depth C2. The first depth C1 is greater than the second depth C2. Therefore, a length of each of the middle fixing rings 115 is greater than a length of each of the side fixing ring 116, so that a contact area between each of the middle fixing rings 115 and the elastic structure 113 is greater than a contact area between each of the side fixing rings 116 and the elastic structure 113, thereby improving the connection stability between the middle fixing rings 115 and the elastic structure 113, and further improving the connection stability between the corresponding bristle bundles and the elastic structure 113.

As shown in FIGS. 12 and 16, in one specific embodiment, the elastic structure 113 comprises a filling layer 1131 and a wrapping layer 1132. The filling layer 1131 covers an outer periphery of the fixing rings 114 and fills each of the rubber filling gaps. The filling layer 1131 defines the bristle fixing surface 113A1. The wrapping layer 1132 is disposed on one side of the filling layer 1131 away from the bristle fixing surface 113A1. The wrapping layer 1132 defines the back surface 113A2, and the wrapping layer 1131 wraps all of the head portions 1122.

As shown in FIGS. 12, 13, and 16, in one specific embodiment, in the third direction Y, a portion of the wrapping layer 1132 corresponding to the middle fixing rings 115 has a first thickness E1, a portion of the wrapping layer 1132 corresponding to the side fixing rings 116 has a second thickness E2. The first thickness E1 is greater than the second thickness E2. Therefore, portions of the wrapping layer 1132 corresponding to the middle fixing rings 115 contact the inner wall of the oral cavity more quickly, and the wrapping layer 1132 that is relatively thick buffers the vibration of the brush head 11 and reduce the vibration sensation caused by the brush head 11 to the inner wall of the oral cavity, thereby improving the comfort of the user when using the brush head 11 for oral cleaning.

As shown in FIGS. 12, 15 and 16, in one specific embodiment, the wrapping layer 1132 comprises an outer protruding portion and an outer peripheral portion 11322. The outer protruding portion corresponding to the middle fixing rings 115. The outer protruding portion surrounds an outer peripheral side of the outer protruding portion and is corresponding to the side fixing rings 116. The outer protruding portion protrudes with respect to the outer peripheral portion 11322. The outer protruding portion is smoothly excessive or is stepped with respect to the outer peripheral portion 11322. In this way, compared with an embodiment where outer protruding portion is flush with the outer protruding portion, the outer protruding portion or the present disclosure protrudes with respect to the outer peripheral portion 11322, so that the outer protruding portion corresponding to the middle fixing rings 115 has a greater probability of contacting the inner wall of the oral cavity of the user, which reduces a possible contact area between the wrapping layer 1132 and the oral cavity of the user. In this way, on the one hand, it is convenient for the brush head 11 to move in the oral cavity of the user for brushing teeth, and on the other hand, it reduces the vibration sensation caused by vibration transmitted to the wrapping layer from the brush head 11 to the inner wall of the oral cavity, so as to improve the comfort of the user when using the brush head 11 for oral cleaning.

As shown in FIG. 11, the embodiments of the present disclosure provide an electric toothbrush 1. The electric toothbrush 1 comprises the brush head 11 and a brush handle 12. The brush head 11 is configured to place into the mouth of the user to clean the oral cavity. The brush handle 12 is configured for the user to hold and use the electric toothbrush 1.

Specifically, the brush handle 12 is connected to the brush head 11 and is configured to drive the brush head 11 to move. When the user holds the brush handle 12 and places the brush head 11 into a part to be cleaned in the oral cavity, the brush head 11 brushes the oral cavity. The brush handle 12 comprises a housing, a bracket, a motor, a battery, etc. The motor and the battery are mounted on the bracket to form a core. The housing defines an accommodating cavity, and the core is mounted in the accommodating cavity. The housing protects the motor and the battery, so a probability of damage to the motor and the battery is reduced.

As shown in FIGS. 12, specifically, the brush head 11 comprises a brush rod 111, bristle bundles 112, an elastic structure 113, and fixing rings 114.

The brush rod 111A defines a first direction L. A first end of the brush rod 111 is configured to connect with an output end of the motor in the first direction L, so that the motor is capable of driving the brush head 11 to move. A second end of the brush rod 111 is connected to the elastic structure 113. The brush rod 111 is made from hard plastic to effectively transmit the vibration energy of the motor.

The bristle bundles 112 are fixed to the elastic structure 113 through the fixing rings 114, and the bristle bundles 112 are configured to contact the oral cavity of the user to clean the oral cavity.

The elastic structure 113 is connected to the second end of the brush rod 111 in the first direction L. The elastic structure 113 defines a bristle fixing surface 113A1 perpendicular to a third direction Y. The third direction Y is perpendicular to the first direction L. The elastic structure 113 is made from silicone, TPE TPU), or PVC, which is not limited thereto. The brush rod 111 is made from hard plastic.

The elastic structure 113 has a strong deformation ability, so that the fixing rings 114 have a strong mobility. When the bristle bundles 112 vibrate, the bristle bundles have a larger vibration amplitude, which not only increase a cleaning area, but also improves a cleaning ability of the bristle bundles 112 for the dead corners of the oral cavity.

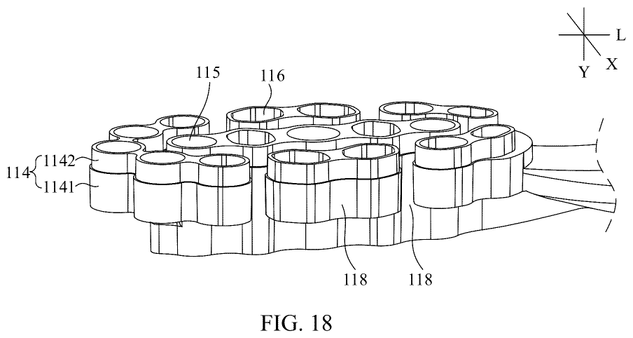

As shown in FIGS. 17 and 18, the fixing rings 114 comprise embedded portions 1141 embedded in the elastic structure 113 and protrusions 1142 protruding from the bristle fixing surface 113A1 of the elastic structure. The bristle bundles 112 are respectively disposed in the fixing rings 114. Each of the bristle bundles 112 extends from a corresponding embedded portion 1141 and extends toward the bristle fixing surface 1131A1 of the elastic structure. The fixing rings 114 are made from hard rubber or hard plastic, so that the fixing rings 114 provide support for the bristle bundles 112.

Specifically, a copper bristle fixing process or a copper-free bristle fixing process is adopted to fix the bristle bundles to the elastic structure 113. For instance, in the copper-free bristle fixing process, one end of each of the bristle bundles 112 passes through a corresponding bristle fixing hole of a corresponding fixing ring 114 first, and then the one end of each of the bristle bundles 112 passing through the corresponding bristle fixing hole are heated to melt, so that each of the bristle bundles 112 is fixedly connected to the corresponding fixing ring 114. Optionally, the bristle bundles 112 are made from nylon material.

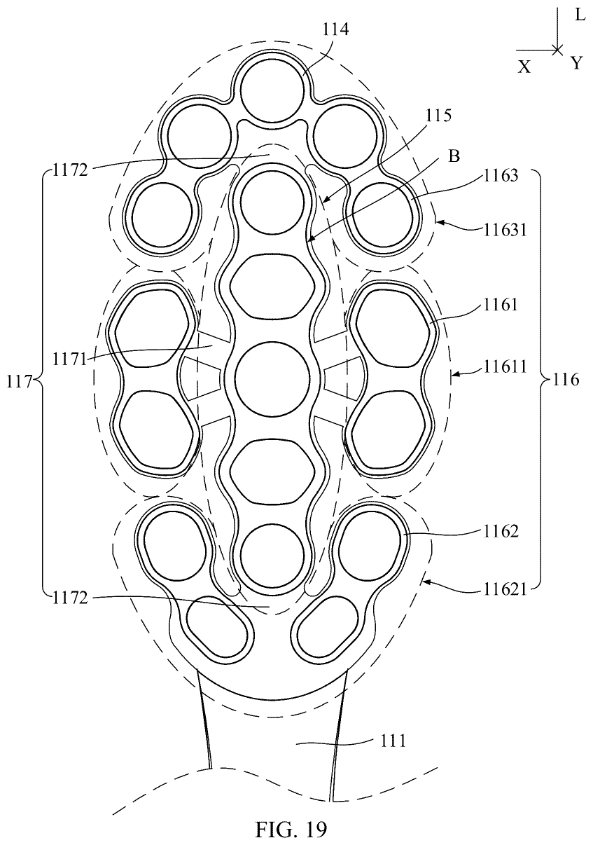

As shown in FIG. 19, the fixing rings 114 comprises middle fixing rings 115 ((as shown in FIG. 19, the fixing rings 115 are framed by dotted frames in a middle portion of the elastic structure) and side fixing rings 116 (the fixing rings 116 disposed around the middle fixing rings 115). The middle fixing rings 115 are located roughly in a middle area of the bristle fixing surface 113A1 of the elastic structure 1113. The side fixing rings 114 surround a peripheral side of the middle fixing rings 114. The side fixing rings 116 are located roughly at an edge area of the bristle fixing surface 113A1 of the elastic structure 113.

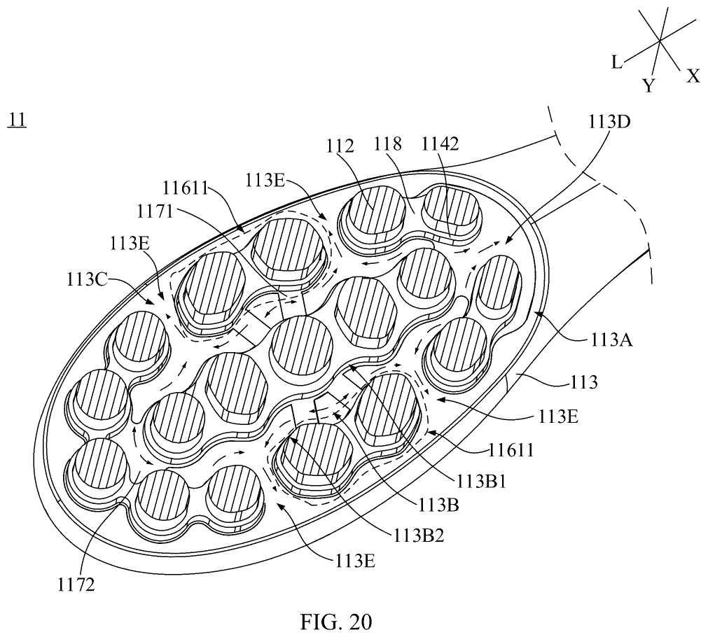

As shown in FIGS. 19-20, the side fixing rings 114 are spaced apart from the middle fixing rings 114, so that a guide channel 113B (see the dashed lines with arrows) is defined between the protrusions 1142 of the side fixing rings 114, the protrusions 1142 of the middle fixing rings 114, and the bristle fixing surface 113A1 of the elastic structure 113. That is, the protrusions 1142 of the side fixing rings 116 constitute a guide side wall 113B1 on a first side of the guide channel 113B, the protrusions 1142 of the middle fixing rings 115 constitute a guide side wall 113B2 on a second side of the guide channel 113B, and corresponding areas of the bristle fixing surface 113A1 of the elastic structure 113 constitute a bottom wall of the guide channel 113B.

Furthermore, guide port 113C is defined between at least two adjacent side fixing rings 116. The guide port 113C is communicated with the guide channel 113B. A bottom portion of the guide port 113C is formed by a partial area of the bristle fixing surface 113A1 of the elastic structure 113, so that the bottom wall of the guide channel 113B and the bottom portion of the guide port 113C are smoothly transitioned.

During a process of brushing teeth, it is inevitable that fluid, such as water for wetting toothpaste or saliva of the user, may flow onto the bristle fixing surface 113A1 of the elastic structure 113. Through a guiding effect of the guide channel 113B, the fluid is collected and guided to the guide port 113C, and is discharged from the bristle fixing surface 113A1 of the elastic structure 113 from the guide port 113C. That is, the fluid on the bristle fixing surface 113A1 of the elastic structure 113 flows along the guide channel 113B and flows out of the bristle fixing surface 113A1 of the elastic structure 113 from the guide port 113C, thereby reducing an amount of the fluid accumulated on the bristle fixing surface 113A1 of the elastic structure 113, reducing a probability of generation of dirt and grime between the bristle bundles 112, and also reducing a probability of bacteria breeding caused by the fluid accumulating on the bristle fixing surface 113A1 of the elastic structure for a long time.

In the embodiment of the present disclosure, the side fixing rings 116 surround the peripheral side of the middle fixing rings 115, so that the guide channel 113B is defined between the protrusions 1142 of the side fixing rings 116, the protrusions 1142 of the middle fixing rings 115, and the bristle fixing surface 113A1 of the elastic structure 113. The guide channel 113B guide the fluid, so that the fluid flows out of the bristle fixing surface 113A1 of the elastic structure 113 through the guide port 113C communicated with the guide channel 113B, a probability that the fluid remains on the bristle fixing surface 113A1 of the elastic structure 113 is reduced, and the bristle fixing surface 113A1 of the elastic structure 113 is kept dry as much as possible, which reduces the probability of bacteria breeding on the bristle fixing surface 113A1 of the elastic structure 113, thereby providing a reliable protection for oral health of the user.

As shown in FIG. 19, the brush head 11 further comprises connecting pieces 117. The side fixing rings 116 are directly or indirectly connected to the middle fixing rings 115 through the connecting pieces 117, so that the fixing rings 114 are connected as a whole. Therefore, it is easy to place all of the fixing rings 114 together in a mold, and to form the elastic structure 113 on the outer sides of the fixing rings 114. In this way, the number of clamps configured to clamp the fixing rings 114 is reduced, as a result, the number of clamping times and the number of working steps are reduced, which improves the production efficiency of the brush head 11. Furthermore, since all of the fixing rings 114 are connected as a whole, it is easy to position the fixing rings 114, thereby improving bristle fixing efficiency of the fixing rings 114.

In other embodiments, the fixing rings 114 may be spaced apart and not connected to each other. In this way, during the brushing process, the fixing rings 114 are subject to force generation by elastic deformation of the elastic structure 113. Because the fixing rings 114 are not connected, each two adjacent fixing rings 114 are able to move closer to each other or move away from each other, thereby making the bristle bundles 112 on the fixing rings 114 have a larger swing range, thereby increasing a cleaning area of each of the bristle bundles 112.

Since the side fixing rings 116 are connected to the middle fixing rings 115 through the connecting pieces 117, it is necessary to consider an influence of the connecting pieces 117 on the guiding effect of the guide channel 113B. Therefore, as shown in FIG. 20, in some embodiments, the connecting pieces 117 are embedded in the elastic structure 113 and are flush with the bristle fixing surface 113A1 of the elastic structure, so that a bottom portion of the guide channel 113B is smooth, which improves smoothness of a movement of the fluid in the guide channel 113B.

In other embodiments, the connecting pieces 117 are completely embedded in the elastic structure 113 so as to be wrapped by the elastic structure 113. Namely, the connecting pieces 117 are not exposed, thereby ensuring a flatness of the bristle fixing surface 113A1 of the elastic structure 113, improving the smoothness of the movement of the fluid in the guide channel 113B, preventing the liquid from remaining on the bristle fixing surface 113A1 of the elastic structure 113, and avoiding an existence of the dead corners on the bristle fixing surface 113A1 of the elastic structure 113, and avoiding an accumulation of dirt in the dead corners.

As shown in FIG. 18, in some embodiments, the middle fixing rings 114, the side fixing rings 114, and the connecting pieces are integrally formed. In this way, not only can a production process thereof be simplified, but also the middle fixing rings 115, the side fixing rings 116, and the connecting pieces 117 have a strong structural strength, thereby improving connection stability between the middle fixing rings 115, the side fixing rings 116, and the connecting pieces 117, reducing a probability of the side fixing rings 116 and the connecting pieces 117 disconnecting from the middle fixing rings 115, and further reducing a probability of the side fixing rings 116 disconnecting from the connecting piece 117.

As shown in FIG. 19, in some embodiments, the side fixing rings 116 comprise first side fixing rings 1161. The first side fixing rings 1161 are respectively disposed on two sides of the middle fixing rings 115 in a second direction X. The second direction X is perpendicular to the first direction L. The connecting pieces 117 comprise elastic connecting sheets 1171. At least the first side fixing rings 1161 are connected to the middle fixing rings 115 through the elastic connecting sheets 1171. In this way, on the basis of realizing a connection between the first side fixing ring 1161 and the middle fixing ring 115, the elastic connecting sheets 1171 have characteristics of elasticity, elastic deformation, sheet shape, and thin thickness, so that the first side fixing rings 1161 have a larger movement amplitude with respect to the middle fixing rings 115 through the elastic connecting sheets 1171, thereby increasing the swing range of the first side fixing rings 1161 and improving the cleaning ability of the first side fixing rings 1161 for the oral cavity of the user.

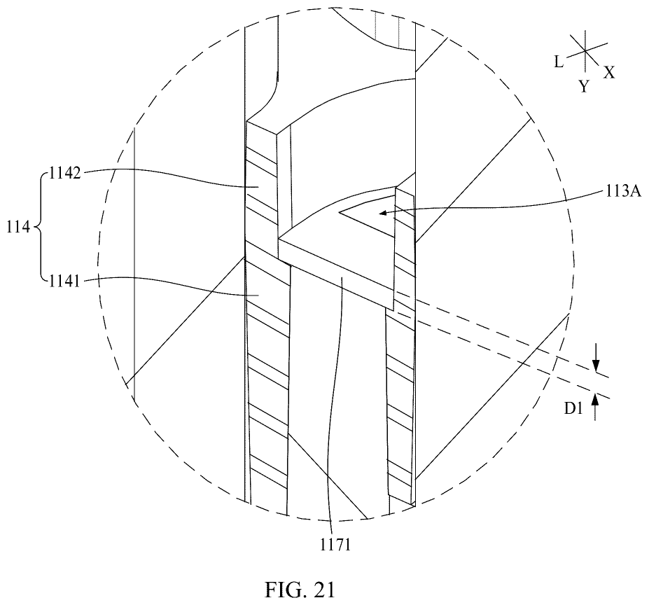

As shown in FIG. 19-21, in some embodiments, the first connecting pieces 117 have a third thickness D3 in the third direction Y. The third thickness D3 is not less than 0.15 mm and not greater than 0.3 mm. On the one hand, the elastic connecting sheets 1171 are enable to have a strong structural strength and a low probability of breaking. On the other hand, the elastic connecting sheets 1171 are enabled to have good elasticity, so that the first side fixing rings 1161 are enabled to have a large movement range with respect to the middle fixing rings 115.

If the third thickness D1 is less than 0.15 mm, the elastic connecting sheets 1171 may be too thin, the structural strength of the elastic connecting sheets 1171 is poor, and the elastic connecting sheets 1171 are easy to break, which eventually cause the first side fixing rings 114 to separate from the middle fixing ring 115. If the third thickness D1 is greater than 0.3 mm, the elastic connecting sheets 1171 is too thick, the elasticity of the elastic connecting sheets 1171 is poor, which reduces the movement range of the first side fixing rings 114, and eventually causes the first side fixing rings 114 to have poor cleaning ability for the oral cavity of the user. For instance, the third thickness D1 is 0.15 mm, 0.2 mm, 0.25 mm, or 0.3 mm.

As shown in FIGS. 19 and 20, in some embodiments, the first side fixing rings 1161 are respectively disposed on two sides of the middle fixing rings 115 in the second direction X. The first side fixing rings 1161 located on a same side of the middle fixing rings 115 are connected to form a first side fixing ring group 11611, and two first side fixing ring groups 11611 are formed. The first side fixing rings 1161 in a same first side fixing ring group 11611 are sequentially connected. The brush head further comprises elastic connecting sheets. That is, no guide port 113C is formed between the first side fixing rings 1161 in the same first side fixing ring group 11611.

Furthermore, as shown in FIG. 19, each of the two first side fixing ring groups 11611 is connected to the middle fixing rings 115 through at least one of the elastic connecting sheets 1171, which ensures that each of the first side fixing ring groups 11611 has a good cleaning effect on the oral cavity of the user. Furthermore, each of the first side fixing ring groups 11611 is connected to the middle fixing rings 115 by only one of the elastic connecting sheets 1171, which further improves the movement amplitude of the first side fixing ring groups 11611 with respect to the middle fixing rings 115, thereby improving the cleaning ability of the first side fixing ring groups 11611 for the oral cavity of the user.

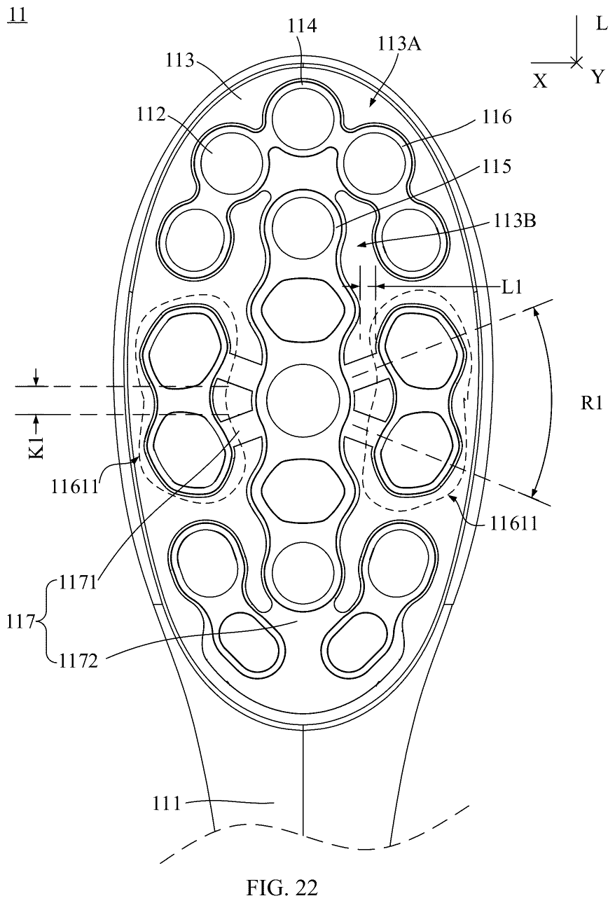

As shown in FIG. 22, in some embodiments, each of the first side fixing rings 1161 is connected to a corresponding middle fixing rings 115 through a corresponding elastic connecting sheet 1171. A first interval K1 is defined between each two adjacent elastic connecting sheets 1171. In the second direction X and from any one of the first side fixing ring groups 11611 to the middle fixing rings 114, each first interval K1 is gradually reduced. In other words, the closer to any one of the first side fixing ring groups 11611, the greater the first interval K1 between the two elastic connecting plates 1171, which can increase the distance between corresponding two first side fixing rings 1161 of the same first side fixing ring group 11611, thereby increasing a twisting amplitude of the first side fixing rings 1161 and improving the cleaning ability of the first side fixing ring groups 11611 on the oral cavity of the user.

As shown in FIG. 22, in some embodiments, the first side fixing rings 1161 are one-to-one connected to the elastic connecting sheets 1171 to connect to the middle fixing rings 115. A first included angle R1 is formed between central axes of each two adjacent elastic connecting sheets 1171. Each first included angle is not less than 30° and not greater than 120°, which increases a distance between the first side fixing rings 1161 in the same first side fixing ring group 11611, thereby increasing the twisting amplitude of the first side fixing rings 1161 to improve the cleaning ability of the first side fixing ring groups 11611 on the oral cavity of the user.

If each first included angle R1 is less than 30°, each first included angle R1 is too small, resulting in the distance between the first side fixing rings 1161 in the same first side fixing ring group 11611 being too close and resulting in small twisting amplitudes of the first side fixing rings 1161, thereby affecting the cleaning effect of the first side fixing ring groups 11611 on the user's oral cavity. If each first included angle R1 is greater than 120°, each first included angle R1 is too large, resulting in the distance between the first side fixing rings 1161 in the same first side fixing ring group 11611 being too long, resulting in a decrease in a bristle ratio (the bristle ratio is understood as a ratio of an area occupied by all of the bristle bundles to an area of the bristle fixing surface of the elastic structure) and resulting in a decrease in tooth cleaning efficiency. For instance, the first included angle R1 is 30°, 35°, 40°, 45°, 50°, 60°, 80°, 100° or 120°.

As shown in FIG. 19, in some embodiments, the side fixing rings 116 comprise second side fixing rings 1162, and third side fixing rings 1163. The second side fixing rings 1162 are disposed between the first side fixing rings 1161 and the brush rod 111. The third side fixing rings 1163 are disposed on one side of the first side fixing rings 1161 away from the brush rod 111.

The connecting pieces 117 further comprise supporting portions 1172. The second side fixing rings 1162 and the third side fixing rings 1163 are respectively connected to the middle fixing rings 115 through the supporting portions 1172. The second side fixing rings 1162 and the third side fixing rings 1163 are connected to the middle fixing rings 115 through different supporting portions 1172.

Furthermore, as shown in FIG. 17, in the third direction Y, each of the supporting portions 1172 has a thickness greater than a thickness of each of the elastic connecting sheets 1171, so that the second side fixing rings 1162 and the third side fixing rings 1163 are stably connected to the middle fixing rings 115 and an overall structure of the brush head 11 is stable, thereby allowing the brush head 11 to have a long service life.

As shown in FIG. 19, in some embodiments, the second side fixing rings 1162 form a second side fixing ring group 11621. The third side fixing rings 1163 form a third side fixing ring group 11631. The first side fixing ring groups 11611 are disposed between the second side fixing ring group 11621 and the third side fixing ring group 11631. The second side fixing ring group 11621 and the third side fixing ring group 11631 are arc-shaped. Two ends of the second side fixing ring group 11621 and two ends of the third side fixing ring group 11631 respectively extend toward the first side fixing ring groups 11611 disposed on the two sides of the middle fixing rings 115, which fits an outer periphery of the brush head 11, thereby increasing the contact area between the brush head 11 and the oral cavity of the user, thereby improving the cleaning ability of the brush head 11 on the oral cavity of the user.

It is understandable that, in other embodiments, the second side fixing ring group 11621 and the third side fixing ring group 11631 may be disposed in a hooking line shape.

As shown in FIG. 20, in some embodiments, guide ports 113C are provided, and each of the guide ports 113C is defined between the fixing ring groups. The guide ports 113C at least comprise a first guide port 113D. The first guide port 113D is defined between each two adjacent side fixing rings 116. A central axis of the brush rod 111 passes through the first guide port 113D. When the user brushes the teeth, the user commonly holds the electric toothbrush 1 vertically, or, after finishing brushing the teeth, the user commonly places the brush head 11 vertically. At this time, the fluid remaining on the bristle fixing surface 113A1 of the elastic structure 113 flows along the guide channel 113B to the first guide port 113D under an action of gravity, and flows out of the bristle fixing surface 113A1 of the elastic structure 113 through the first guide port 113D. Therefore, the bristle fixing surface 113A1 of the elastic structure 113 is kept as dry as possible, thereby reducing the probability of bacteria breeding on the bristle fixing surface 113A1 of the elastic structure 113.

Furthermore, portions of the guide channel 113B on two sides of the middle fixing rings 115 extend roughly in the first direction L. In this way, when the electric toothbrush 1 is in a vertical state, the fluid on the bristle fixing surface 113A1 of the elastic structure 113 flows more smoothly to the first guide port 113D, so as to discharge the fluid from the bristle fixing surface 113 more quickly and thoroughly.

As shown in FIG. 20, in some embodiments, the guide ports comprise second guide ports 113E. The second guide ports 113E are defined between the second side fixing ring group 11621 and the first side fixing ring groups 11611. Alternatively, the second guide ports 113E are defined between the third side fixing ring group 11631 and the first side fixing ring groups 11611. Alternatively, the second guide ports 113E are defined between the second side fixing ring group 11621 and the first side fixing ring groups 11611, and are further defined between the third side fixing ring group 11631 and the first side fixing ring groups 11611.

The second guide ports 113E extend in the second direction X. When the user uses the brush head 11 to clean the oral cavity, the electric toothbrush 1 is placed horizontally, or the electric toothbrush 1 is tilted (the brush head 11 is at the top at this time). Under the action of gravity, the fluid on the bristle fixing surface 113A1 of the elastic structure 113 flows to the second guide ports 113E through the guide channel 111B, and flows out of the bristle fixing surface 113A1 of the elastic structure 113 from the second guide ports 113E. It is understood that when the electric toothbrush 1 is tilted, part of the fluid also flows out of the bristle fixing surface 113A1 of the elastic structure 113 from the first guide port 113D.

Furthermore, when the electric toothbrush 1 is in use, the brush head 11 reciprocates with the first direction L as a rotation axis. Since the second guide ports 113E extend in the second direction X, a swing direction of the brush head 11 is consistent with the second direction X. Thus, a surface tension of the fluid on the bristle fixing surface 113A1 of the elastic structure 113 is overcome by swinging of the brush head 11, so that the fluid is spun-out from the second guide ports 113E and the fluid is more thoroughly discharged from the bristle fixing surface 113A1 of the elastic structure 113. It is understood that when the brush head 11 reciprocates with the first direction L as the rotation axis, the fluid also moves accordingly and flows on the bristle fixing surface 113A1 of the elastic structure 113, which is also conducive to the fluid flowing to the first guide port 113D and being discharged.

In addition, when the electric toothbrush 1 is in use, the motor may drive the brush head 11 to perform telescopic movement in the first direction L, and the central axis of the brush rod 111 runs through the first guide port 113D. An extension direction of the first guide port 113D is consistent with a telescopic direction of the brush head 11 (i.e., in the first direction L). In this way, the surface tension of the fluid on the bristle fixing surface 113A1 of the elastic structure 113 is overcome by the telescopic movement of the brush head 11, enabling the fluid to flow out from the first guide port 113D, thereby the fluid is more thoroughly discharged from the bristle fixing surface 113A1 of the elastic structure 113. It is understood that when the brush head 11 performs the telescopic movement in the first direction L, the fluid also moves accordingly and flows on the bristle fixing surface 113A1 of the elastic structure 113, which is also conducive to the fluid flowing to the second guide port 113E and being discharged.

As shown in FIG. 19, in some embodiments, in the second direction X perpendicular to the first direction L, the side fixing rings 116 disposed on two opposite sides of the middle fixing rings 115 are symmetrically disposed with respect to the central axis of the brush rod 111, which makes the middle fixing rings 115 evenly stressed, so as to reduce a probability of damage to the middle fixing rings 115, thereby making the middle fixing rings 115 have a long service life, and making the brush head 11 have a long service life.

As shown in FIG. 22, in some embodiments, the guide channel 113B has a first width L1, and the first width L1 is not less than 0.8 mm and not greater than 2 mm. By such arrangement, the guide channel 113B is made wider, making it easier to overcome the surface tension between the fluid and channel walls of the guide channel 113B, so that the fluid is allowed to flow in the guide channel 113B, thereby facilitating the fluid to flow out from the bristle fixing surface 113A1 of the elastic structure 113 through the guide ports 113C. In addition, when the area of the bristle fixing surface 113A1 of the elastic structure 113 is the same, the first width the guide channel 113B makes an area occupied by the bristle bundles 112 larger, which increases the contact area between the bristle bundles 112 and the oral cavity of the user, thereby improving the cleaning efficiency of the brush head 11 on the oral cavity of the user.

If the first width L1 is less than 0.8 mm, the guide channel 113B is too narrow, which may hinder the movement of the fluid in the guide channel 113B and may cause the fluid to accumulate on the bristle fixing surface 113A1 of the elastic structure 113. If the first width L1 is greater than 2 mm, the area occupied by the bristle bundle 112 is smaller when the area of the bristle fixing surface 113A1 of the elastic structure 113 is fixed, resulting in a smaller contact area between the bristle bundles 112 and the oral cavity of the user, and resulting in a poor cleaning ability on the oral cavity of the user by the brush head 11. Specifically, the first width L1 may be 0.8 mm, 0.9 mm, 1 mm, 1.5 mm, or 2 mm.

As shown in FIGS. 19-20, in some embodiments, an outer contour line formed by all of the middle fixing rings 114 is a wavy line B configured to guide the fluid. The wave line B reduces the probability of liquid remaining on the bristle fixing surface 113A1 of the elastic structure 113.

Furthermore, at least part of the guide ports 113C is disposed opposite to wave crests of the wave line B. That is, the wave crests of the wave line B are protruding toward the guide ports 113C, and the fluid in the flow guide channel 113B is guided to flow toward the flow guide ports 113C through the wave crests, so that the fluid is more easily discharged from the bristle fixing surface 113A1 of the elastic structure 113.

Furthermore, at least part of the side fixing rings 116 is disposed opposite to a wave troughs of the wave line B. On the one hand, it makes the guide ports 113C being disposed opposite to the wave crests; on the other hand, compared with a scheme where the side fixing rings 116 are disposed opposite to the wave crests of the wave line B, the wave troughs are concave, so that the guide channel 113B between the wave troughs and the side fixing rings 116 opposite to the wave troughs has a greater flow width, which is conducive to the flow of fluid in the guide channel 113B.

As shown in FIG. 20, in some embodiments, each two adjacent middle fixing rings 115 are connected by a corresponding connecting portion 118, and two adjacent side fixing rings 114 without a corresponding guide port defined therebetween are connected through a corresponding connecting portion 118, so that continuous flow guide side walls are formed. Therefore, the fluid is enabled to flow in the guide channel 113B, and the guide channel 113B guides a movement direction of the fluid, thereby facilitating the fluid to flow out of the bristle fixing surface 113A1 of the elastic structure 113 from the guide ports 113C.

As shown in FIG. 18, in some embodiments, a top end of each of the connecting portions 118 is flush with a top end of each of the protrusions 1142, so that the guide side walls 113B1 that are continuous and complete are formed, which reduces the dead angles between the connecting pieces 117 and the fixing rings 114 and reduces the probability of fluid remaining in the dead angles.

As shown in FIG. 17-18, in some embodiments, the embedded portions 1141 have first cross sections parallel to the bristle fixing surface 113A1 of the elastic structure 113, the protrusions have second cross sections parallel to the bristle fixing surface 113A1 of the elastic structure 113. An area of each of the first cross sections is greater than an area of each of the second cross sections. That is, a diameter of each of the protrusions 1142 is less than a diameter of each of the embedded portions 1141. In this way, the connection area between the fixing rings and the elastic structure 113 is increased by the embedded portions 1141, and the connection stability between the fixing rings 114 and the elastic structure 113 is improved. In addition, the width of the guide channel 113B is made larger by the protrusions 1142 having a smaller diameter, thereby facilitating the movement of the fluid in the guide channel 113B. A stepped surface is formed at a connection between each of the protrusions 1141 and a corresponding embedded portion 1142. Each stepped surface is flush with the bristle fixing surface 113A1 of the elastic structure, which prevents generation of the dead angles on the bristle fixing surface 113A1 of the elastic structure 113 and reduces the probability of fluid remaining in the dead angles.

Although the embodiments of the present disclosure are shown and described above, it can be understood that the above-mentioned embodiments are illustrative and should not be regarded as limitations of the present disclosure. Those of ordinary skill in the art can make changes, modifications, substitutions, and variations to the above-mentioned embodiments within the scope of the present disclosure.

What is claimed is:

1. A brush head, comprising:
a brush rod,
a brush plate, and
an elastic structure;
wherein the brush rod extends in a first direction; the brush plate is disposed on the brush rod; the brush plate comprises a middle mounting portion and two side mounting portions; the two side mounting portions are respectively disposed on two sides of the middle mounting portion in a second direction; at least one of the middle mounting portion and the two side mounting portions is connected to the brush neck portion;
the middle mounting portion and the two side mounting portions comprise fixing rings configured to mount bristle bundles; in the third direction, a thickness of each of the fixing rings of the middle mounting portion is greater than a thickness of each of the fixing rings of the two side mounting portion; the first direction, the second direction, and the third direction are perpendicular to each other; the elastic structure is wrapped around outer peripheral walls of the fixing rings.

2. The brush head according to claim 1, wherein in the third direction, the middle mounting portion and one side of each of the side mounting portions are located on a same plane; or
in the third direction, two ends of the middle mounting portion are raised with respect to the two side mounting portions; or
in the third direction, a first end of the middle mounting portion is raised with respect to the two side mounting portions and a second end of the middle mounting portion is recessed with respect to the two side mounting portions.

3. The brush head according to claim 1, wherein in the second direction, a wall thickness of each of the fixing rings of the middle mounting portion is greater than a wall thickness of each of the fixing rings of the two side mounting portions.

4. The brush head according to claim 1, wherein when being subjected to a brushing force, a deformation quantity of the middle mounting portion is less than a deformation quantity of each of the side mounting portions.

5. The brush head according to claim 1, wherein areas of cross sections of at least part of the fixing rings of the middle mounting portion are different from areas of cross sections of at least part of the fixing rings of the two side mounting portions; and/or
shapes of the at least part of the fixing rings of the middle mounting portion are different from shapes of the at least part of the fixing rings of the two side mounting portions.

6. The brush head according to claim 1, wherein the brush plate is integrally formed, and/or the brush rod and the brush plate are integrally formed.

7. The brush head according to claim 1, wherein at least part of the fixing rings of the middle mounting portion is movable, and/or the middle mounting portion is movable with respect to the brush rod.

8. The brush head according to claim 1, wherein the middle mounting portion comprises a first fixing ring group and a second fixing ring group; the first fixing ring group is located at an end portion of the middle mounting portion and is connected to the second fixing ring group through a third connecting piece; the first fixing ring group is capable of swinging with respect to the second fixing ring group; the first fixing ring group comprises at least one fixing ring; the second fixing ring group comprises a plurality of fixing rings.

9. The brush head according to claim 1, wherein The middle mounting portion is connected to the brush rod, and/or the middle mounting portion is at least connected to one of the two side mounting portions; the middle mounting portion is capable of swinging and/or being deformed with respect to the brush rod.

10. The brush head according to claim 9, wherein the two side mourning portions are connected to the brush rod; the middle mounting portion is connected to at least one of the two side mounting portions through at least one first connecting piece; one end of the middle mounting portion facing the brush neck portion is spaced apart from the brush rod.

11. The brush head according to claim 10, wherein the at least one first connecting piece comprises a plurality of first connecting pieces; the middle mounting portion is connected to the two side mounting portions through the plurality of first connecting pieces; the plurality of first connecting pieces are elastically deformable; the plurality of first connecting pieces are embedded in the elastic structure to be wrapped by the elastic structure; the plurality of first connecting pieces are not exposed at all, or the plurality of first connecting pieces do not protrude with respect to the elastic structure.

12. The brush head according to claim 1, wherein at least part of the fixing rings of the two side mounting portions are movable with respect to the brush rod; the at least part of the fixing rings of the two side mounting portions is connected to the middle mounting portion and/or the brush rod.

13. The brush head according to claim 12, wherein at least one of the two side mounting portions comprises portions disposed at intervals; the portions thereof comprise corresponding fixing rings, a first one of the portions thereof is connected to the brush rod, and a second one of the portions thereof is connected to the middle mounting portion through at least one first connecting piece; the at least one first connecting piece is embedded in the elastic structure to be wrapped by the elastic structure; the at least one first connecting piece is not exposed at all, or the at least one first connecting piece does not protrude with respect to the elastic structure.

14. The brush head according to claim 1, wherein ends of the two side mounting portions away from the brush head are connected to surround an end portion of the middle mounting portion.

15. The brush head according to claim 1, wherein the brush head comprises recessed portions; each of the recessed portions is formed at a connection portion of each two fixing rings connected to each other;
in the second direction, each of the recessed portions of the middle mounting portion directly faces an outer peripheral wall of a corresponding fixing ring of one of the two side mounting portions; and/or
each of the recessed portions of the two side mounting portions directly faces an outer peripheral wall of a corresponding fixing ring of the middle mounting portion.

16. The brush head according to claim 1, wherein the fixing rings comprise bristle fixing holes; each of the bristle fixing holes runs through a corresponding fixing ring in the third direction; at least one of the bristle fixing holes comprises a middle section and two end sections; the middle section and the end sections are disposed in the third direction; the middle section is communicated with the end sections; at least part of areas of cross sections of the end sections gradually decreases in a direction toward the middle section.

17. The brush head according to claim 16, wherein in the third direction, areas of cross sections of the middle section are equal to each other.

18. The brush head according to claim 1, wherein a thickness of the elastic structure gradually increases from an outer side wall of the brush head to a middle portion of the brush head.

19. The brush head according to claim 1, wherein the elastic structure completely wraps connecting pieces disposed between the middle mounting portion and the two side mounting portions; and/or
the elastic structure completely wraps a connecting piece disposed between the middle mounting portion and the brush rod; and/or
the elastic structure completely wraps connecting pieces disposed between the side mounting portions and the brush neck portion.

20. A toothbrush, comprising:
a brush handle; and
a brush head;
wherein the brush head comprises a brush rod, a brush plate, and an elastic structure; the brush rod extends in a first direction; the brush plate is disposed on the brush rod; the brush plate comprises a middle mounting portion and two side mounting portions; the two side mounting portions are respectively disposed on two sides of the middle mounting portion in a second direction; at least one of the middle mounting portion and the two side mounting portions is connected to the brush neck portion;
wherein the middle mounting portion and the two side mounting portions comprise fixing rings configured to mount bristle bundles; in the third direction, a thickness of each of the fixing rings of the middle mounting portion is greater than a thickness of each of the fixing rings of the two side mounting portion; the first direction, the second direction, and the third direction are perpendicular to each other; the elastic structure is wrapped around outer peripheral walls of the fixing rings.
